(19) United States
(12) Patent Application Publication
(10) Pub. No.: US 2026/0311641 A1
(43) Pub. Date: Oct. 8, 2026

(54) DISPLAY DEVICE AND ELECTRONIC DEVICE

(71) Applicant: Samsung Display Co., Ltd., Yongin-si (KR)

(72) Inventors: Dong Woo KIM, Yongin-si (KR); Kyung Bae KIM, Yongin-si (KR); Yeon Kyung KIM, Yongin-si (KR); Yong Hee LEE, Yongin-si (KR)

(21) Appl. No.: 19/387,239

(22) Filed: Nov. 12, 2025

(30) Foreign Application Priority Data
Apr. 8, 2025 (KR) 10-2025-0045067

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0233; G09G 2320/045

(57) ABSTRACT

The present disclosure relates to a display device and an electronic device capable of improving image quality. The display device includes a pixel including a light-emitting element connected between a driving voltage line and a common voltage line, a first transistor connected between the driving voltage line and the light-emitting element, and including a gate electrode connected to a first node and a source electrode connected to a second node, a second transistor including a gate electrode connected to a gate line and configured to receive a gate signal, a source electrode connected to a data line, and a drain electrode connected to the first node, and a fourth transistor connected between the first transistor and the light-emitting element, and including a gate electrode configured to receive a control signal having a value between an active voltage of the gate signal and a non-active voltage of the gate signal.

### CROSS-REFERENCE TO RELATED APPLICATION

The present application claims priority to, and the benefit of, Korean Patent Application No. 10-2025-0045067, filed on Apr. 8, 2025, in the Korean Intellectual Property Office, the entire disclosure of which is incorporated herein by reference.

### BACKGROUND

### 1. Field

The present disclosure relates to a display device and an electronic device capable of improving image quality.

### 2. Description of the Related Art

Because an organic light-emitting diode (OLED) display is self-emissive and does not require a separate light source, unlike a liquid crystal display, its thickness and weight may be reduced. In addition, an OLED display has garnered attention as a next-generation display for TVs, monitors, and portable electronic devices due to its superior characteristics, such as low power consumption, high luminance, and high response speed.

### SUMMARY

Aspects of present disclosure provide a display device and an electronic device capable of improving image quality.

According to an aspect of the present disclosure, there is provided a display device including a pixel, wherein the pixel includes a light-emitting element connected between a driving voltage line and a common voltage line, a first transistor connected between the driving voltage line and the light-emitting element, and including a gate electrode connected to a first node and a source electrode connected to a second node, a second transistor including a gate electrode connected to a gate line and configured to receive a gate signal, a source electrode connected to a data line, and a drain electrode connected to the first node, and a fourth transistor connected between the first transistor and the light-emitting element, and including a gate electrode configured to receive a control signal having a value between an active voltage of the gate signal and a non-active voltage of the gate signal.

The fourth transistor and the second transistor may include a same type of transistor, wherein the control signal is greater than the active voltage and less than the non-active voltage.

The control signal may include a direct current signal.

The control signal may include a pulse signal having a non-active voltage, and an active voltage having a value between the active voltage of the gate signal and the non-active voltage of the gate signal.

The fourth transistor and the second transistor may include a same type of transistor, wherein the active voltage of the control signal is greater than an active voltage of the gate signal and less than a non-active voltage of the gate signal.

The pixel may further include a fifth transistor connected between an initialization voltage line and a contact point between the fourth transistor and the light-emitting element.

The fifth transistor may include a type of transistor that is opposite to that of the fourth transistor.

The control signal may have a value between an active voltage of an initialization gate signal configured to be applied to the fifth transistor and a non-active voltage of the initialization gate signal.

The control signal may include a pulse signal having a non-active voltage, and an active voltage that is greater than the non-active voltage of the initialization gate signal and less than the active voltage of the initialization gate signal.

The pixel may further include a third transistor connected between the driving voltage line and the second node.

The gate electrode of the third transistor may be connected to the second node.

The gate electrode of the third transistor may be connected to an emission control line configured to transmit an emission control signal.

The pixel may further include a sixth transistor connected between the first node and a reference voltage line.

The pixel may further include a third transistor connected between the driving voltage line and the second node, and including a gate electrode connected to the second node, a fifth transistor connected between an initialization voltage line and a contact point between the fourth transistor and the light-emitting element, and a capacitor connected between the driving voltage line and the first node, wherein the control signal includes a pulse-shaped emission control signal.

The pixel may further include a third transistor connected between the driving voltage line and the second node, a fifth transistor connected between and an initialization voltage line and a contact point between the fourth transistor and the light-emitting element, and a capacitor connected between the driving voltage line and the first node, wherein the control signal includes a cascode voltage, which includes a direct current voltage.

The pixel may further include a sixth transistor connected between the first node and a reference voltage line.

According to an aspect of the present disclosure, there is provided an electronic device including a display device having a pixel, the pixel including a light-emitting element connected between a driving voltage line and a common voltage line, a first transistor connected between the driving voltage line and the light-emitting element, and including a gate electrode connected to a first node and a source electrode connected to a second node, a second transistor including a gate electrode configured to receive a gate signal from a gate line, a source electrode connected to a data line, and a drain electrode connected to the first node, and a fourth transistor connected between the first transistor and the light-emitting element, and including a gate electrode configured to receive a control signal having a value between an active voltage of the gate signal and a non-active voltage of the gate signal.

The fourth transistor and the second transistor may include a same type of transistor, wherein the control signal is greater than the active voltage and less than the non-active voltage.

The control signal may include a direct current signal.

The control signal may include a pulse signal having a non-active voltage, and an active voltage having a value between the active voltage of the gate signal and the non-active voltage of the gate signal.

According to one or more embodiments, the image quality of the display device and the electronic device may be improved.

For example, in a pixel of a display device of one or more embodiments, an emission control signal (or a cascode voltage) is applied to a gate electrode of a transistor (e.g., a third transistor) connected between a driving transistor and a light-emitting element, and the active voltage of the emission control signal may have a value between an active voltage and a non-active voltage of a gate signal applied to another transistor (e.g., a second transistor). Therefore, the turned-on fourth transistor may have high resistance.

Accordingly, even if a deviation occurs between the driving voltage and the common voltage due to deterioration of the light-emitting element, the influence of the source-drain voltage of the driving transistor on the driving current may be substantially ignored due to the high resistance characteristics of the fourth transistor and, thus, the deviation of the driving current of the driving transistor may be reduced or minimized. Therefore, even if the deviation occurs between the driving voltage and the common voltage due to deterioration of the light-emitting element, the luminance of the light-emitting element may be maintained substantially uniformly.

The aspects of the present disclosure are not limited to the above-described aspects, and other aspects that are not described herein will become apparent to those skilled in the art from the following description.

### BRIEF DESCRIPTION OF THE DRAWINGS

The above and other aspects of the present disclosure will become more apparent by describing in detail embodiments thereof with reference to the attached drawings, in which:

FIG. 1 is an exploded perspective view showing a display device according to one or more embodiments;

FIG. 2 is a block diagram illustrating a display device according to one or more embodiments;

FIG. 3 is an equivalent circuit diagram of a pixel according to one or more embodiments;

FIG. 4 is a timing diagram of an emission control signal, an initialization gate signal, a write gate signal, and a data voltage of FIG. 3;

FIG. 5 is a diagram illustrating the operation of the display device of FIG. 3 in the first period of FIG. 4;

FIG. 6 is a diagram illustrating the operation of the display device of FIG. 3 in the second period of FIG. 4;

FIG. 7 is a diagram illustrating the operation of the display device of FIG. 3 in the third period of FIG. 4;

FIG. 8 is a diagram illustrating the operation of the display device of FIG. 3 in the fourth period of FIG. 4;

FIG. 9 is an equivalent circuit diagram of the pixel according to one or more other embodiments;

FIG. 10 is a timing diagram of the emission control signal, the initialization gate signal, the write gate signal, and the data signal of FIG. 9;

FIG. 11 is an equivalent circuit diagram of the pixel according to still one or more other embodiments;

FIG. 12 is an equivalent circuit diagram of the pixel according to still one or more other embodiments;

FIG. 13 is an equivalent circuit diagram of the pixel according to one or more embodiments;

FIG. 14 is a timing diagram of the emission control signal, the initialization gate signal, the write gate signal, the cascode voltage, and the data voltage of FIG. 13;

FIG. 15 is a diagram illustrating the operation of the display device of FIG. 13 in the first period of FIG. 14;

FIG. 16 is a diagram illustrating the operation of the display device of FIG. 13 in the second period of FIG. 14;

FIG. 17 is a diagram illustrating the operation of the display device of FIG. 13 in the third period of FIG. 14;

FIG. 18 is a diagram illustrating the operation of the display device of FIG. 3 in the fourth period of FIG. 4;

FIG. 19 is an equivalent circuit diagram of the pixel according to one or more other embodiments:

FIG. 20 is a timing diagram of the emission control signal, the initialization gate signal, the write gate signal, and the data signal of FIG. 19;

FIG. 21 is an equivalent circuit diagram of the pixel according to one or more embodiments;

FIG. 22 is a timing diagram of the emission control signal, the reference gate signal, the write gate signal, the initialization gate signal, the cascode voltage, and the data voltage of FIG. 21;

FIG. 23 is a diagram illustrating the operation of the display device of FIG. 21 in the first period of FIG. 22;

FIG. 24 is a diagram illustrating the operation of the display device of FIG. 21 in the second period of FIG. 22;

FIG. 25 is a diagram illustrating the operation of the display device of FIG. 21 in the third period of FIG. 22;

FIG. 26 is a diagram illustrating the operation of the display device of FIG. 21 in the fourth period of FIG. 22;

FIG. 27 is an equivalent circuit diagram of the pixel according to one or more other embodiments;

FIG. 28 is an equivalent circuit diagram of the pixel according to one or more other embodiments;

FIG. 29 is a timing diagram of the emission control signal, the reference gate signal, the write gate signal, the initialization gate signal, the cascode voltage, and the data signal of FIG. 28;

FIG. 30 is an equivalent circuit diagram of the pixel according to one or more other embodiments;

FIG. 31 is an equivalent circuit diagram of the pixel according to one or more other embodiments;

FIGS. 32, 33, 34, and 35 are diagrams illustrating aspects of a display device according to one or more embodiments;

FIG. 36 is a block diagram of an electronic device according to one or more embodiments; and

FIGS. 37, 38 and 39 are schematic diagrams illustrating electronic devices according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments are described herein with reference to schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

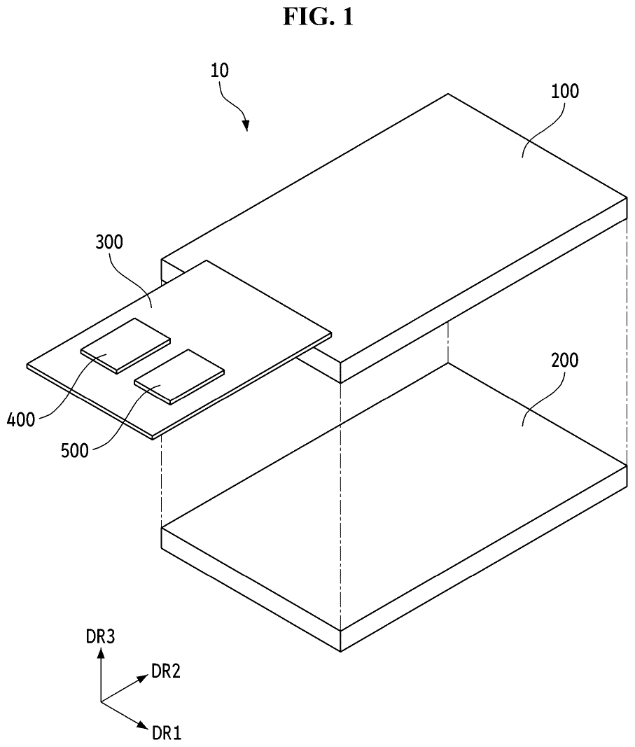

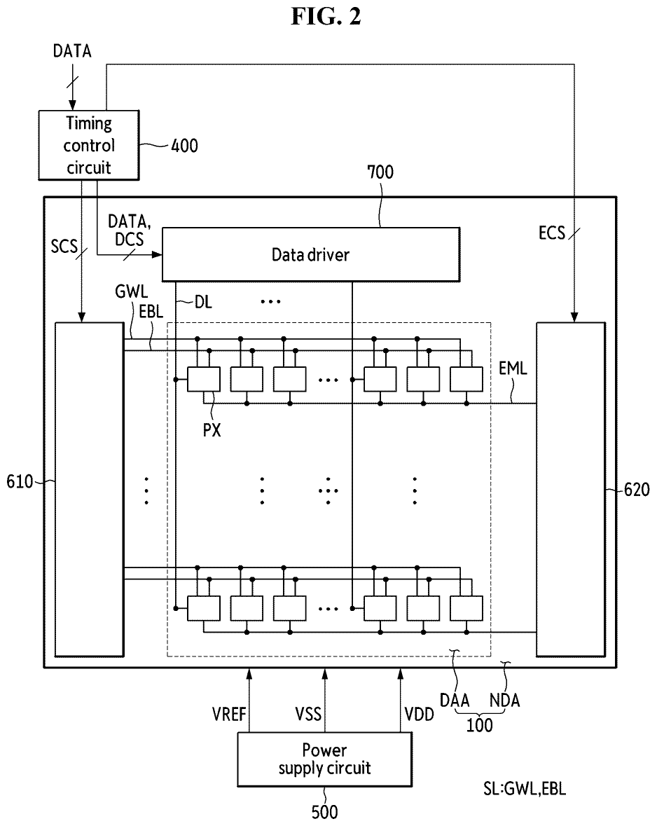

FIG. 1 is an exploded perspective view showing a display device according to one or more embodiments. FIG. 2 is a block diagram illustrating a display device according to one or more embodiments.

Referring to FIGS. 1 and 2, a display device 10 according to one or more embodiments is a device displaying a moving image or a still image. The display device 10 according to one or more embodiments may be applied to portable electronic devices, such as a mobile phone, a smartphone, a tablet personal computer, a mobile communication terminal, an electronic organizer, an electronic book, a portable multimedia player (PMP), a navigation system, an ultra-mobile PC (UMPC) or the like. For example, the display device 10 according to one or more embodiments may be applied as a display unit of a television, a laptop, a monitor, a billboard, or an Internet-of-Things (IoT) terminal. Alternatively, the display device 10 according to one or more embodiments may be applied to a smart watch, a watch phone, a head-mounted display (HMD) for implementing virtual reality and augmented reality, and the like.

The display device 10 according to one or more embodiments may include a display panel 100, a heat dissipation layer 200, a circuit board 300, a timing control circuit 400, and a power supply circuit 500.

The display panel 100 may have a planar shape similar to a quadrilateral shape. For example, the display panel 100 may have a planar shape similar to a quadrilateral shape, having a short side of a first direction DR1 and a long side of a second direction DR2 crossing the first direction DR1. In the display panel 100, a corner where a short side in the first direction DR1 and a long side in the second direction DR2 meet may be right-angled or rounded with a selected curvature. The planar shape of the display panel 100 is not limited to a quadrilateral shape, and may be a shape similar to another polygonal shape, a circular shape, or an elliptical shape. The planar shape of the display device 10 may conform to the planar shape of the display panel 100, but the present disclosure is not limited thereto.

The display panel 100 may include a plurality of pixels PX, a plurality of gate lines GL, an emission control line EML, a plurality of data lines DL, a gate driver 610, an emission driver 620, and a data driver 800. The display panel 100 may be divided into a display area DAA displaying an image and a non-display area NDA not displaying an image as shown in FIG. 2.

The plurality of pixels PX may be arranged in the display area DAA. The plurality of pixels PX may be arranged in a matrix form in the first direction DR1 and the second direction DR2. The plurality of gate lines GL and emission control lines EML may extend in the first direction DR1, while being arranged in the second direction DR2. The plurality of data lines DL may extend in the second direction DR2, while being arranged in the first direction DR1. Here, a plurality of pixels PX (e.g., three adjacent pixels PX) that are located adjacently and provide light of different colors may form one unit pixel.

Each of the plurality of pixels PX may include a plurality of transistors (e.g., pixel transistors). The plurality of pixel transistors may be formed by a semiconductor process, and may be formed on a semiconductor substrate (e.g., wafer). For example, each of the plurality of pixel transistors may be a metal-oxide-semiconductor field-effect transistor (MOSFET).

A plurality of gate lines GL may include a plurality of write gate lines GWL and a plurality of initialization gate lines EBL.

Each of the plurality of pixels PX may be connected to any one write gate line GWL among the plurality of write gate lines GWL, any one initialization gate line GIL among a plurality of initialization gate lines GIL, any one emission control line EML among the plurality of emission control lines EML, and any one data line DL among the plurality of data lines DL. Each of the plurality of pixels PX may receive the data voltage of the data line DL according to the write gate signal of the write gate line GWL, and may emit light from a light-emitting element thereof according to the data voltage.

The gate driver 610, the emission driver 620, and the data driver 800 may be located in the non-display area NDA.

The gate driver 610 may include a plurality of gate transistors, and the emission driver 620 may include a plurality of light-emitting transistors. The plurality of gate transistors and the plurality of light-emitting transistors may be formed through a semiconductor process, and may be formed on the semiconductor substrate. For example, the plurality of gate transistors and the plurality of light-emitting transistors may each be a MOSFET.

The gate driver 610 may generate write gate signals according to a gate-timing control signal SCS of the timing control circuit 400, and may sequentially output the write gate signals to the write gate lines GWL. In addition, the gate driver 610 may generate initialization gate signals according to the gate-timing control signal SCS, and may sequentially output the initialization gate signals to the initialization gate lines EBL.

The emission driver 620 may generate emission control signals in response to the emission-timing control signal ECS, and may sequentially output them to the emission control lines EML.

The data driver 800 may include a plurality of data transistors, and the plurality of data transistors may be formed on the semiconductor substrate through a semiconductor process. For example, each of the plurality of data transistors may be a MOSFET.

The data driver 800 may receive digital video data DATA and a data-timing control signal DCS from the timing control circuit 400. The data driver 800 may convert the digital video data DATA into analog data voltages according to the data-timing control signal DCS, and may output the analog data voltages to the data lines DL. In this case, the pixels PX may be selected by the write gate signal of the gate driver 610, and data voltages may be supplied to the selected pixels PX.

The heat dissipation layer 200 may overlap the display panel 100 in a third direction DR3, which is a thickness direction of the display panel 100. The heat dissipation layer 200 may be located on one surface (e.g., the rear surface) of the display panel 100. The heat dissipation layer 200 may serve to dissipate heat generated from the display panel 100. The heat dissipation layer 200 may include a metal layer having high thermal conductivity, such as graphite, silver (Ag), copper (Cu), or aluminum (Al).

The circuit board 300 may be electrically connected to a plurality of pads in a pad portion of the display panel 100 by using a conductive adhesive member, such as an anisotropic conductive film. The circuit board 300 may be a flexible printed circuit board with a flexible material, or a flexible film. Although the circuit board 300 is illustrated in FIG. 1 as being unfolded, the circuit board 300 may be bent. In this case, one end of the circuit board 300 may be located on the rear surface of the display panel 100 and/or the rear surface of the heat dissipation layer 200. The other end of the circuit board 300 may be connected to the plurality of pads in the pad portion of the display panel 100 by using the conductive adhesive member. One end of the circuit board 300 may be an opposite end of the other end of the circuit board 300.

The timing control circuit 400 may receive digital video data and timing signals inputted from the outside. The timing control circuit 400 may generate the gate-timing control signal SCS, the emission-timing control signal ECS, and the data-timing control signal DCS for controlling the display panel 100 in response to the timing signals. The timing control circuit 400 may output the gate-timing control signal SCS to the gate driver 610, and may output the emission-timing control signal ECS to the emission driver 620. The timing control circuit 400 may output the digital video data and the data-timing control signal DCS to the data driver 800.

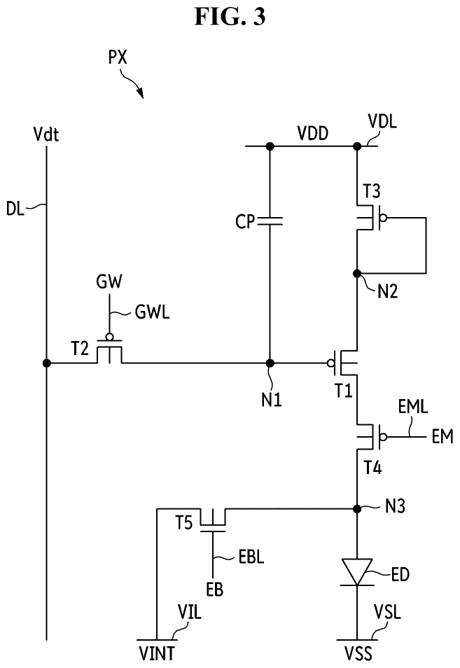

The power supply circuit 500 may generate a plurality of panel driving voltages according to a power voltage from the outside. For example, the power supply circuit 500 may generate a driving voltage VDD, a common voltage VSS, and an initialization voltage VINT and supply them to the display panel 100. The driving voltage VDD, the common voltage VSS, and the initialization voltage VINT will be described later in conjunction with FIG. 3.

Each of the timing control circuit 400 and the power supply circuit 500 may be formed as an integrated circuit (IC) and attached to one surface of the circuit board 300. In this case, the gate-timing control signal SCS, the emission-timing control signal ECS, the digital video data DATA, and the data-timing control signal DCS of the timing control circuit 400 may be supplied to the display panel 100 through the circuit board 300. In addition, the common voltage VSS, the driving voltage VDD, and the initialization voltage VINT of the power supply circuit 500 may be supplied to the display panel 100 through the circuit board 300.

Alternatively, each of the timing control circuit 400 and the power supply circuit 500 may be located in the non-display area NDA of the display panel 100, similarly to the gate driver 610, the emission driver 620, and the data driver 800. In this case, the timing control circuit 400 may include a plurality of timing transistors, and each power supply circuit 500 may include a plurality of power transistors. The plurality of timing transistors and the plurality of power transistors may be formed through a semiconductor process, and may be formed on the semiconductor substrate. For example, the plurality of timing transistors and the plurality of power transistors may each be a MOSFET. Each of the timing control circuit 400 and the power supply circuit 500 may be located between the data driver 800 and the pad portion.

FIG. 3 is an equivalent circuit diagram of a pixel according to one or more embodiments.

Referring to FIG. 3, the pixel PX may be connected to the write gate line GWL, the initialization gate line EBL, the emission control line EML, and the data line DL. In addition, the pixel PX may be connected to a driving voltage line VDL to which the driving voltage VDD is applied, a common voltage line VSL to which the common voltage VSS is applied, and an initialization voltage line VIL to which the initialization voltage VINT is applied.

The driving voltage VDD, the common voltage VSS, and the initialization voltage VINT may each be a direct current (DC) voltage. The initialization voltage VINT may be greater than the common voltage VSS and less than the driving voltage VDD. For example, the driving voltage VDD may have a value of of about 5 V, the common voltage VSS may have a value of about −2 V, and the initialization voltage VINT may have a value of about 0 V.

The pixel PX may include a plurality of transistors T1, T2, T3, T4, and T5, a light-emitting element ED, and a capacitor CP.

The light-emitting element ED may emit light in response to a driving current flowing in the channel of the first transistor T1. A light emission amount of the light-emitting element ED may be proportional to the driving current. The light-emitting element ED may be connected between the fourth transistor T4 and the common voltage line VSL. For example, the first electrode (e.g., the anode electrode) of the light-emitting element ED may be connected to the drain electrode (e.g., a third node N3) of the fourth transistor T4, and the second electrode (e.g., the cathode electrode) of the light-emitting element ED may be connected to the common voltage line VSL. The light-emitting element ED may be an organic light-emitting diode including a first electrode, a second electrode, and an organic light-emitting layer located between these electrodes (e.g., the first electrode and the second electrode), but the present disclosure is not limited thereto. For example, the light-emitting element ED may be an inorganic light-emitting element including a first electrode, a second electrode, and an inorganic semiconductor located between these electrodes (e.g., the first electrode and the second electrode), in which case the light-emitting element ED may be a micro light-emitting diode.

The first transistor T1 may be a driving transistor that controls the amount (or density) of a drain-source current (e.g., driving current) flowing between the drain electrode and the source electrode according to the voltage applied to the gate electrode. The first transistor T1 may include a gate electrode connected to a first node N1, a source electrode connected to a second node N2, and a drain electrode connected to a source electrode of the fourth transistor T4. In addition, the first transistor T1 may further include a body electrode connected to the driving voltage line VDL.

The second transistor T2 may be controlled by the write gate signal GW, and the second transistor T2 may be connected between the data line DL and the first node N1. The second transistor T2 may include a gate electrode connected to the write gate line GWL, a source electrode connected to the data line DL, and a drain electrode connected to the first node N1. In addition, the second transistor T2 may further include a body electrode connected to the driving voltage line VDL. The write gate line GWL may transmit the write gate signal GW.

The third transistor T3 may be controlled by the voltage of the second node N2, and the third transistor T3 may be connected between the driving voltage line VDL and the second node N2. For example, the third transistor T3 may be coupled as a diode between the driving voltage line VDL and the second node N2. The third transistor T3 may include a gate electrode connected to the second node N2, a source electrode connected to the driving voltage line, and a drain electrode connected to the second node N2. In addition, the third transistor T3 may further include a body electrode connected to the driving voltage line VDL.

The fourth transistor T4 may be controlled by an emission control signal EM, which is a control signal (e.g., a pulse-shaped control signal), and the fourth transistor T4 may be connected between the drain electrode of the first transistor T1 and the third node N3. The fourth transistor T4 may include a gate electrode connected to the emission control line EML, a source electrode connected to the drain electrode of the first transistor T1, and a drain electrode connected to the third node N3. In addition, the fourth transistor T4 may further include a body electrode connected to the driving voltage line VDL. The emission control line EML may transmit the emission control signal EM.

The fifth transistor T5 may be controlled by an initialization gate signal EB, and the fifth transistor T5 may be connected between the third node N3 and the initialization voltage line VIL. The fifth transistor T5 may include a gate electrode connected to the initialization gate line EBL, a drain electrode connected to the third node N3, and a source electrode connected to the initialization voltage line VIL. In addition, the fifth transistor T5 may further include a body electrode connected to the initialization voltage line VIL. The initialization gate line EBL may transmit the initialization gate signal EB, and the initialization voltage line VIL may transmit the initialization voltage VINT.

The first to fifth transistors T1, T2, T3, T4, and T5 described above may each be a metal-oxide-semiconductor field-effect transistor (MOSFET). In this case, at least two of the first to fifth transistors T1, T2, T3, T4, and T5 may be transistors of different types. For example, the first to fourth transistors T1, T2, T3, and T4 may each be a p-type MOSFET, and the fifth transistor T5 may be an n-type MOSFET.

The capacitor CP may be connected between the driving voltage line VDL and the first node N1.

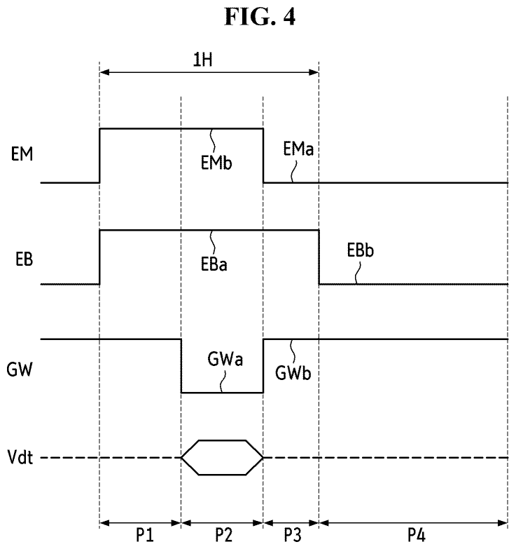

FIG. 4 is a timing diagram of the emission control signal EM, the initialization gate signal EB, the write gate signal GW, and a data voltage Vdt of FIG. 3.

Referring to FIG. 4, the display device 10 may operate based on a first period P1, a second period P2, a third period P3, and a fourth period P4.

The emission control signal EM, the initialization gate signal EB, and the write gate signal GW, which are provided as pulse signals, may have active voltages EMa, EBa, and GWa or non-active voltages EMb, EBb, and GWb, respectively, for each of the periods P1, P2, P3, and P4 described above. Here, the active voltages EMa, EBa, and GWa of the respective signals EM, EB, and GW described above may refer to voltages of a level that may turn on the corresponding transistor to which the corresponding signal is applied. In other words, the signal of the active voltage may have a value that is greater than the threshold voltage of the corresponding transistor. For example, when the transistor is an n-type transistor, the active voltage of the signal applied to the gate electrode of the corresponding transistor may refer to a high level (e.g., positive polarity level or high voltage level).

The non-active voltage of each of the signals EM, EB, and GW may refer to a voltage of a level that may turn off the transistor. In other words, a signal of the non-active voltage may have a value that is less than the threshold voltage of the corresponding transistor. For example, when the corresponding transistor is an n-type transistor, the non-active voltage of the signal applied to the gate electrode of the corresponding transistor may mean a low level (e.g., negative polarity level or low voltage level).

In contrast, when the transistor is a p-type transistor, the active voltage of each of the signals EM, EB, and GW applied to the gate electrode of the transistor may refer to a low level (e.g., negative polarity level or low voltage level), and the non-active voltage of the signal applied to the gate electrode of the corresponding transistor may refer to a high level (e.g., positive polarity level or high voltage level).

For example, as illustrated in FIG. 4, the emission control signal EM may have the active voltage EMa of a low level and the non-active voltage EMb of a high level, the initialization gate signal EB may have the active voltage EBa of a high level and the non-active voltage EBb of a low level, and the write gate signal GW may have the active voltage GWa of a low level and the non-active voltage GWb of a high level.

The non-active voltage EMb of the emission control signal EM, the active voltage EBa of the initialization gate signal EB, and the non-active voltage GWb of the write gate signal GW may be the same. For example, the non-active voltage EMb of the emission control signal EM, the active voltage EBa of the initialization gate signal EB, and the non-active voltage GWb of the write gate signal GW may each have a voltage of about 5 V.

The non-active voltage EBb of the initialization gate signal EB and the active voltage GWa of the write gate signal GW may be the same. For example, the non-active voltage EBb of the initialization gate signal EB and the active voltage GWa of the write gate signal GW may each have a voltage of about 0 V.

The active voltage EMa of the emission control signal EM may be different from the active voltage GWa of the write gate signal GW (or the non-active voltage EBb of the initialization gate signal EB). For example, the active voltage EMa of the emission control signal EM may be greater than the active voltage GWa of the write gate signal GW (or the non-active voltage EBb of the initialization gate signal EB). For example, the active voltage EMa of the emission control signal EM may be about 2 V, and the active voltage GWa of the write gate signal GW and the non-active voltage EBb of the initialization gate signal EB may each be about 0 V.

In addition, the active voltage EMa of the emission control signal EM may be less than the non-active voltage GWb of the write gate signal GW (or the active voltage EBa of the initialization gate signal EB). For example, the active voltage EMa of the emission control signal EM may be about 2 V, and the non-active voltage GWb of the write gate signal GW and the active voltage EBa of the initialization gate signal EB may each be about 5 V.

According to one or more embodiments, the active voltage EMa of the emission control signal EM may have a value between the active voltage GWa of the write gate signal GW (or the non-active voltage EBb of the initialization gate signal EB) and the non-active voltage GWb of the write gate signal GW (or the active voltage EBa of the initialization gate signal EB). For example, the active voltage EMa of the emission control signal EM applied to the gate electrode of the fourth transistor T4 may be greater than the active voltage GWa of the write gate signal GW applied to the gate electrode of the second transistor T2 of the same type as the type of the fourth transistor T4, and may be less than the non-active voltage GWb of the write gate signal GW. For a similar example, the active voltage EMa of the emission control signal EM applied to the gate electrode of the fourth transistor T4 may be greater than the non-active voltage GWb of the initialization gate signal EB applied to the gate electrode of the fifth transistor T5 of the opposite type to the type of the fourth transistor T4, and may be less than the active voltage EBa of the initialization gate signal EB.

In FIG. 4, one horizontal period 1H may be defined as a period in which the initialization gate signal EB is maintained at the active voltage EBa.

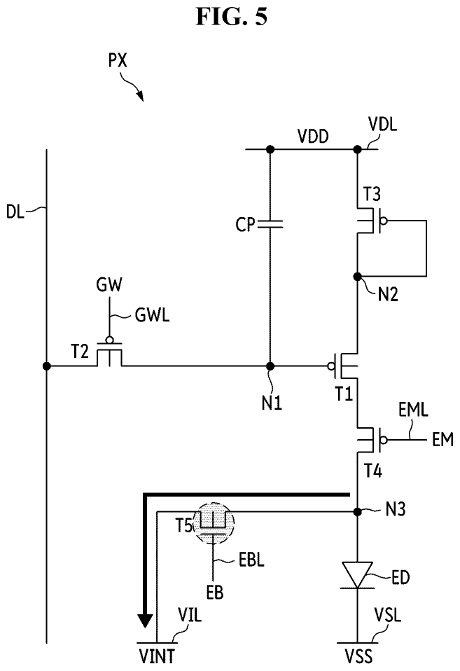

The operation of the display device 10 according to one or more embodiments will be described with reference to FIGS. 4, 5, 6, 7, and 8 as follows. In FIGS. 5 to 8, transistors surrounded by dotted/dashed circles are in a turn-on state, and transistors other than those surrounded by the dotted/dashed circles are in a turn-off state. In addition, arrows in FIGS. 5 to 8 indicate current flow.

First, the operation of the display device 10 in the first period P1 will be described with reference to FIGS. 4 and 5.

FIG. 5 is a diagram illustrating the operation of the display device 10 of FIG. 3 in the first period P1 of FIG. 4. The first period P1 may be, for example, an initialization period.

As illustrated in FIG. 4, the initialization gate signal EB may have the active voltage EBa in the first period P1. On the other hand, the emission control signal EM and the write gate signal GW may have the non-active voltages EMb and GWb in the first period P1.

The initialization gate signal EB of the active voltage EBa may be applied to the gate electrode of the fifth transistor T5 through the initialization gate line EBL. Accordingly, the fifth transistor T5 may be turned on.

The emission control signal EM of the non-active voltage EMb may be applied to the gate electrode of the fourth transistor T4 through the emission control line EML. Accordingly, the fourth transistor T4 may be turned off.

The write gate signal GW of the non-active voltage GWb may be applied to the gate electrode of the second transistor T2 through the write gate line GWL. Accordingly, the second transistor T2 may be turned off.

Because the fifth transistor T5 is turned on as described above, the initialization voltage VINT from the initialization voltage line VIL may be applied to the third node N3 (e.g., the first electrode of the light-emitting element ED) through the turned-on fifth transistor T5. Accordingly, the voltage of the third node N3 may be initialized to the initialization voltage VINT. For example, the first electrode (e.g., the anode electrode) of the light-emitting element ED may be initialized to the initialization voltage VINT.

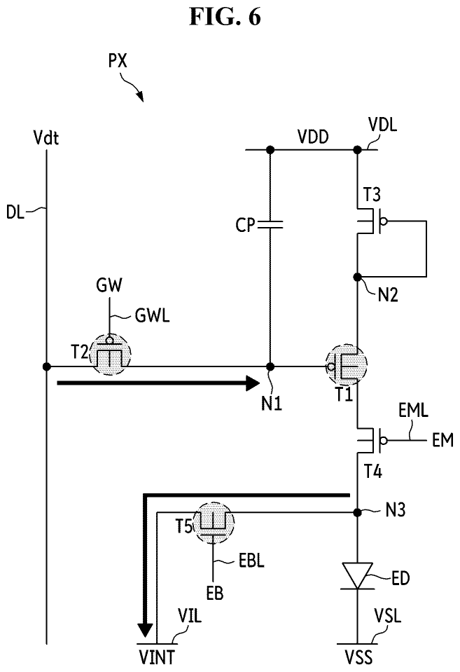

Next, the operation of the display device 10 in the second period P2 will be described with reference to FIGS. 4 and 6. The second period P2 may be a data write period.

FIG. 6 is a diagram illustrating the operation of the display device 10 of FIG. 3 in the second period P2 of FIG. 4.

As illustrated in FIG. 4, in the second period P2, the write gate signal GW and the initialization gate signal EB may have the active voltages GWa and EBa, respectively. On the other hand, in the second period P2, the emission control signal EM may have the non-active voltage EMb. Further, in the second period P2, the data voltage Vdt may be applied to the data line DL. For example, in the second period P2, the data voltage Vdt corresponding to the pixel PX may be applied to the data line DL.

The write gate signal GW of the active voltage GWa may be applied to the gate electrode of the second transistor T2 through the write gate line GWL. Accordingly, the second transistor T2 may be turned on.

The initialization gate signal EB of the active voltage EBa may be applied to the gate electrode of the fifth transistor T5 through the initialization gate line EBL. Accordingly, the fifth transistor T5 may be turned on.

The emission control signal EM of the non-active voltage EMb may be applied to the gate electrode of the fourth transistor T4 through the emission control line EML. Accordingly, the fourth transistor T4 may be turned off.

Because the second transistor T2 is turned on as described above, the data voltage Vdt from the data line DL may be applied to the gate electrode (e.g., the first node N1) of the first transistor T1 through the turned-on second transistor T2. In this case, the data voltage Vdt may be maintained at the first node N1 by the capacitor CP.

Because the data voltage Vdt is applied to the first node N1 through the turned-on second transistor T2, the first transistor T1 connected to the first node N1 through the gate electrode may be turned on.

In addition, because the fifth transistor T5 is maintained in a turned-on state as described above, the voltage of the third node N3 may be maintained at the initialization voltage VINT.

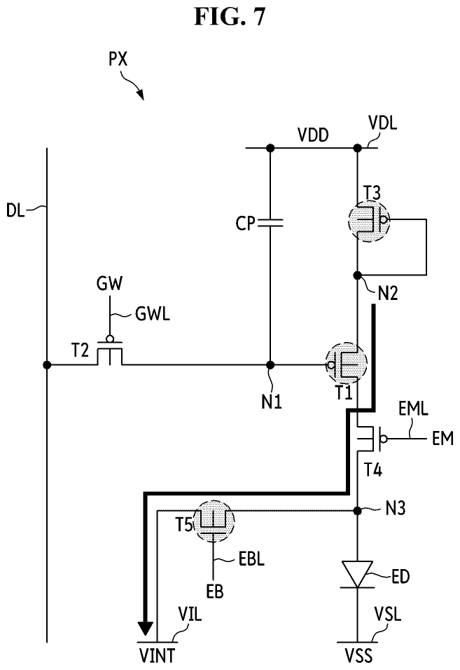

Next, the operation of the display device 10 in the third period P3 will be described with reference to FIGS. 4 and 7. The third period P3 may be an anode holding period.

FIG. 7 is a diagram illustrating the operation of the display device 10 of FIG. 3 in the third period P3 of FIG. 4.

As illustrated in FIG. 4, in the third period P3, the emission control signal EM and the initialization gate signal EB may have the active voltages EMa and EBa, respectively. On the other hand, in the third period P3, the write gate signal GW may have the non-active voltage GWb.

The emission control signal EM of the active voltage GWa may be applied to the gate electrode of the fourth transistor T4 through the emission control line EML. Accordingly, the fourth transistor T4 may be turned on.

The initialization gate signal EB of the active voltage EBa may be applied to the gate electrode of the fifth transistor T5 through the initialization gate line EBL. Accordingly, the fifth transistor T5 may be turned on.

The write gate signal GW of the non-active voltage GWb may be applied to the gate electrode of the second transistor T2 through the write gate line GWL. Accordingly, the second transistor T2 may be turned off.

The first transistor T1 may be maintained in a turned-on state by the data voltage Vdt applied to the first node N1.

Because each of the first transistor T1, the fourth transistor T4, and the fifth transistor T5 is turned on as described above, the source electrode (e.g., the second node N2) of the first transistor T1, the drain electrode of the first transistor T1, and the first electrode (e.g., the third node N3) of the light-emitting element ED may each be initialized to the initialization voltage VINT through the turned-on first transistor T1, the turned-on fourth transistor T4, and the turned-on fifth transistor T5. Because the second node N2 is initialized to the initialization voltage VINT, the third transistor T3 connected to the second node N2 through the gate electrode may be turned on.

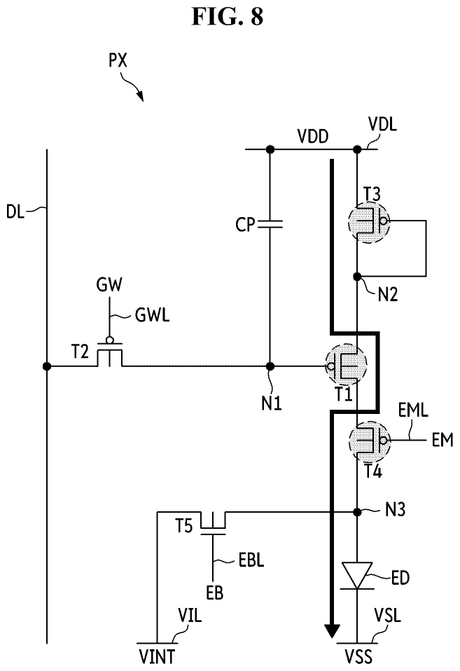

Next, the operation of the display device 10 in the fourth period P4 will be described with reference to FIGS. 4 and 8. The fourth period P4 may be, for example, an emission period P4.

FIG. 8 is a diagram illustrating the operation of the display device 10 of FIG. 3 in the fourth period P4 of FIG. 4.

As illustrated in FIG. 4, the emission control signal EM may have an active voltage in the fourth period P4. On the other hand, each of the initialization gate signal EB and the write gate signal GW may have a non-active voltage in the fourth period P4.

The emission control signal EM of the active voltage may be applied to the gate electrode of the fourth transistor T4 through the emission control line EML. Accordingly, the fourth transistor T4 may be turned on.

The initialization gate signal EB of the non-active voltage may be applied to the gate electrode of the fifth transistor T5 through the initialization gate line EBL. Accordingly, the fifth transistor T5 may be turned off.

The write gate signal GW of the non-active voltage may be applied to the gate electrode of the second transistor T2 through the write gate line GWL. Accordingly, the second transistor T2 may be turned off.

The first transistor T1 may be maintained in a turned-on state by the data voltage Vdt maintained at the first node N2.

The third transistor T3 may be maintained in a turned-on state by the initialization voltage applied to the second node in the previous period P3.

Because each of the third transistor T3, the first transistor T1, and the fourth transistor T4 is turned on as described above, a driving current may be supplied to the light-emitting element ED through the turned-on third transistor T3, the turned-on first transistor T1, and the turned-on fourth transistor T4. Therefore, the light-emitting element ED may emit light according to the driving current.

According to one or more embodiments, the pixel PX may include the fourth transistor T4 connected between the driving transistor (e.g., the first transistor T1) and the light-emitting element ED. In this case, the active voltage EMa of the emission control signal EM applied to the fourth transistor T4 may have a value between the active voltage GWa and the non-active voltage GWb of the gate signal (e.g., the write gate signal GW) applied to the gate electrode of another transistor (e.g., the second transistor T2) of the pixel PX. For example, the active voltage EMa of the emission control signal EM may be greater than the active voltage GWa of the gate signal (e.g., the write gate signal GW) applied to a transistor (e.g., the second transistor T2) of the same type (e.g., p-type) as the type of the fourth transistor T4, and may be less than the non-active voltage GWb of the gate signal (e.g., the write gate signal GW). Therefore, the resistance of the turned-on fourth transistor T4 may be greater than the resistance of another turned-on transistor (e.g., the second transistor T2). For example, in the fourth period T4, the turned-on fourth transistor T4 may have a resistance of several hundreds of mega ohms to several hundreds of giga ohms. Accordingly, even if a deviation occurs between the driving voltage VDD and the common voltage VSS due to the deterioration of the light-emitting element ED, the influence of the source-drain voltage of the first transistor T1 on the driving current may be substantially ignored due to the high resistance characteristics of the fourth transistor T4 and, thus, the deviation of the driving current of the first transistor T1 may be reduced or minimized. Therefore, even if the deviation occurs between the driving voltage VDD and the common voltage VSS due to the deterioration of the light-emitting element ED, the luminance of the light-emitting element ED may be maintained substantially uniformly in the fourth period P4. In other words, even if the light-emitting element ED deteriorates, the image quality deterioration of the display device 10 may be reduced or minimized.

The active voltage EMa of the emission control signal EM applied to the fourth transistor T4 may be greater than the non-active voltage EBb of the gate signal (e.g., the initialization gate signal EB) applied to a transistor (e.g., the fifth transistor T5) of the opposite type (e.g., n-type) to the type of the fourth transistor T4, and may be less than the active voltage EBa of the gate signal (e.g., the initialization gate signal EB).

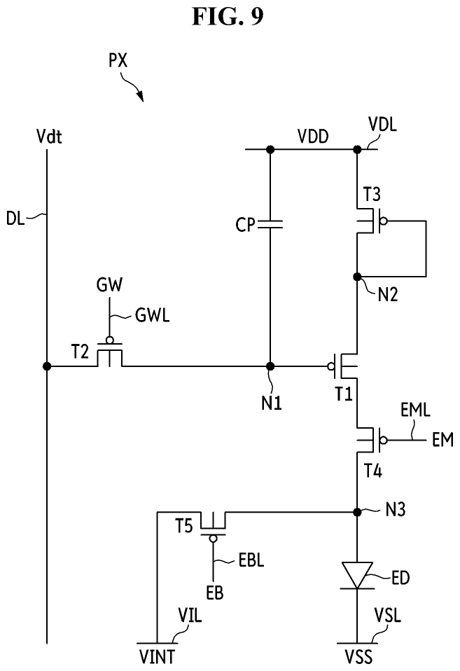

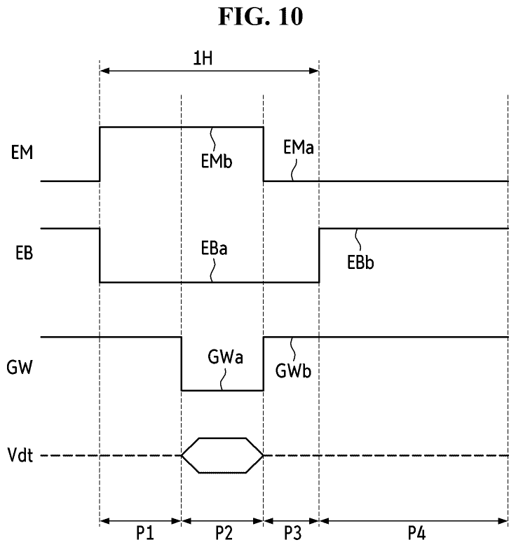

FIG. 9 is an equivalent circuit diagram of the pixel PX according to one or more other embodiments, and FIG. 10 is a timing diagram of the emission control signal EM, the initialization gate signal EB, the write gate signal GW, and the data signal Vdt of FIG. 9.

The pixel PX of FIG. 9 is different from the pixel PX of FIG. 3 described above in that the fifth transistor T5 is a p-type MOSFET, and the difference will be mainly described as follows.

As illustrated in FIG. 9, the fifth transistor T5 of the pixel PX may be a p-type MOSFET. Accordingly, as illustrated in FIG. 10, the initialization gate signal EB inputted to the gate electrode of the fifth transistor T5 may be different from the initialization gate signal EB of FIG. 4 described above. For example, as illustrated in FIG. 10, the initialization gate signal EB may have a low level (e.g., negative polarity level or low voltage level) as the active voltage EBa in each of the first period P1, the second period P2, and the third period P3, and may have a high level (e.g., positive polarity level or high voltage level) as the non-active voltage EBb in the fourth period P4.

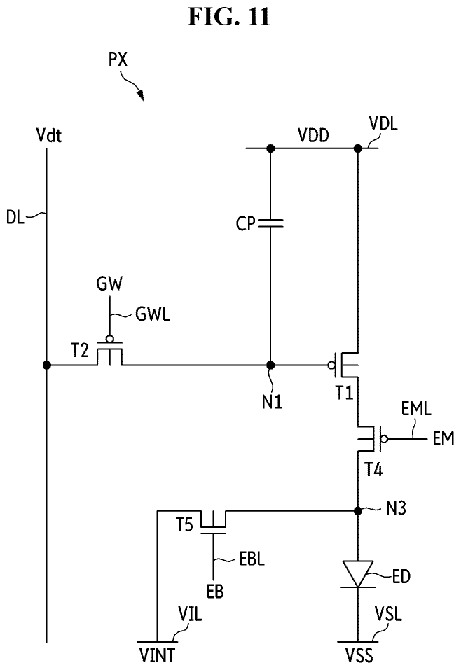

FIG. 11 is an equivalent circuit diagram of the pixel PX according to still one or more other embodiments.

The pixel PX of FIG. 11 is different from the pixel PX of FIG. 3 described above in that the third transistor T3 is not included, and the difference will be mainly described as follows.

As illustrated in FIG. 11, the pixel PX may include the light-emitting element ED, the first transistor T1, the second transistor T2, the fourth transistor T4, the fifth transistor T5, and the capacitor CP. In other words, the third transistor T3 of the pixel PX may be omitted.

Because the third transistor T3 is omitted, the first transistor T1 may be directly connected to the driving voltage line VDL. For example, the source electrode of the first transistor T1 may be directly connected to the driving voltage line VDL.

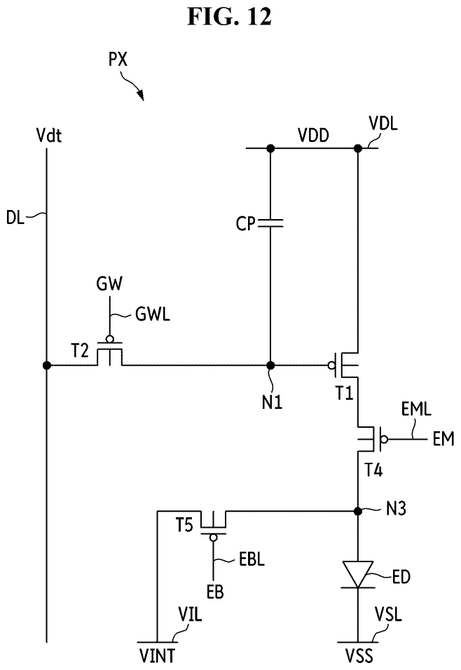

FIG. 12 is an equivalent circuit diagram of the pixel PX according to still one or more other embodiments.

The pixel PX of FIG. 12 is different from the pixel PX of FIG. 11 described above in that the fifth transistor T5 is a p-type MOSFET, and the difference will be mainly described as follows.

As illustrated in FIG. 12, the fifth transistor T5 of the pixel PX may be a p-type MOSFET. In such a case, as illustrated in FIG. 10, the initialization gate signal EB may have a low level (e.g., negative polarity level or low voltage level) as the active voltage EBa in each of the first period P1, the second period P2, and the third period P3, and may have a high level (e.g., positive polarity level or high voltage level) as the non-active voltage EBb in the fourth period P4.

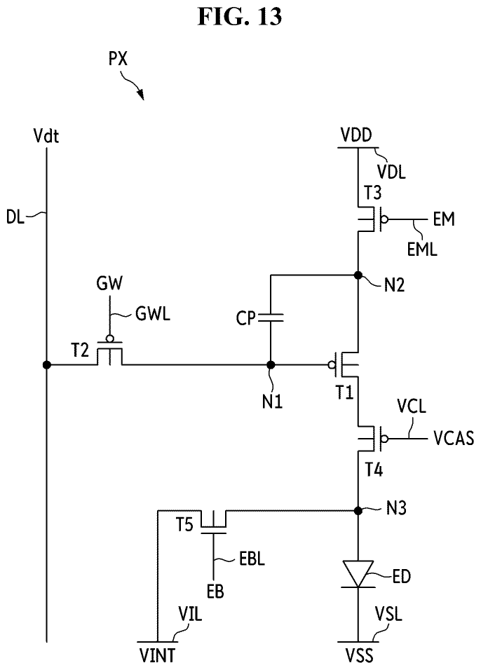

FIG. 13 is an equivalent circuit diagram of the pixel PX according to one or more embodiments.

Referring to FIG. 13, the pixel PX may be connected to the write gate line GWL, the initialization gate line EBL, the emission control line EML, and the data line DL. In addition, the pixel PX may be connected to the driving voltage line VDL to which the driving voltage VDD is applied, the common voltage line VSL to which the common voltage VSS is applied, the initialization voltage line VIL to which the initialization voltage VINT is applied, and a cascode line VCL to which a cascode voltage VCAS is applied.

The driving voltage VDD, the common voltage VSS, the initialization voltage VINT, and the cascode voltage VCAS may each be a DC voltage. The initialization voltage VINT may be greater than the common voltage VSS and less than the driving voltage VDD. For example, the driving voltage VDD may have a value of about 5 V, the common voltage VSS may have a value of about −2 V, the initialization voltage VINT may have a value of about 0 V, and the cascode voltage VCAS may have a voltage of about 2 V.

The above-described cascode voltage VCAS may be a control signal for controlling the fourth transistor. The value of the cascode voltage VCAS may be the same as, for example, the value of the active voltage EMa of the light-emitting control signal EM of FIG. 4. In other words, the cascode voltage VCAS may have a value between the active voltage and the non-active voltage of the gate signal applied to a transistor different from the transistor (e.g., the fourth transistor T4) to which the cascode voltage VCAS is applied. For example, the cascode voltage VCAS may have a value between the active voltage GWa of the write gate signal GW (or the non-active voltage EBb of the initialization gate signal EB) and the non-active voltage GWb of the write gate signal GW (or the active voltage EBa of the initialization gate signal EB). In one or more embodiments, the cascode voltage VCAS applied to the gate electrode of the fourth transistor T4 may be greater than the active voltage GWa of the write gate signal GW applied to the gate electrode of the second transistor T2 of the same type as the type of the fourth transistor T4, and may be less than the non-active voltage GWb of the write gate signal GW. For a similar example, the cascode voltage VCAS applied to the gate electrode of the fourth transistor T4 may be greater than the non-active voltage GWb of the initialization gate signal EB applied to the gate electrode of the fifth transistor T5 of the opposite type to the type of the fourth transistor T4, and may be less than the active voltage EBa of the initialization gate signal EB.

The pixel PX may include a plurality of transistors T1, T2, T3, T4, and T5, a light-emitting element ED, and a capacitor CP.

Here, the light-emitting element ED, the first transistor T1, the second transistor T2, and the fifth transistor T5 of FIG. 13 are the same as the light-emitting element ED, the first transistor T1, the second transistor T2, and the fifth transistor T5 of FIG. 3 described above, respectively, so that the detailed description of the light-emitting element ED, the first transistor T1, the second transistor T2, and the fifth transistor T5 of FIG. 13 refers to FIG. 3 described above and the related description.

The third transistor T3 may be controlled by the emission control signal EM, and the third transistor T3 may be connected between the driving voltage line VDL and the second node N2. The third transistor T3 may include a gate electrode connected to the emission control line EML, a source electrode connected to the driving voltage line, and a drain electrode connected to the second node N2. In addition, the third transistor T3 may further include a body electrode connected to the driving voltage line VDL.

The fourth transistor T4 may be controlled by the cascode voltage VCAS, and the fourth transistor T4 may be connected between the drain electrode of the first transistor T1 and the third node N3. The fourth transistor T4 may include a gate electrode connected to the cascode line VCL, a source electrode connected to the drain electrode of the first transistor T1, and a drain electrode connected to the third node N3. In addition, the fourth transistor T4 may further include a body electrode connected to the driving voltage line VDL. The cascode line VCL may transmit the cascode voltage VCAS.

The first to fifth transistors T1, T2, T3, T4, and T5 described above may each be a MOSFET. In this case, at least two of the first to fifth transistors T1, T2, T3, T4, and T5 may be transistors of different types. For example, the first to fourth transistors T1, T2, T3, and T4 may each be a p-type MOSFET, and the fifth transistor T5 may be an n-type MOSFET.

The capacitor CP may be connected between the first node N1 and the second node N2.

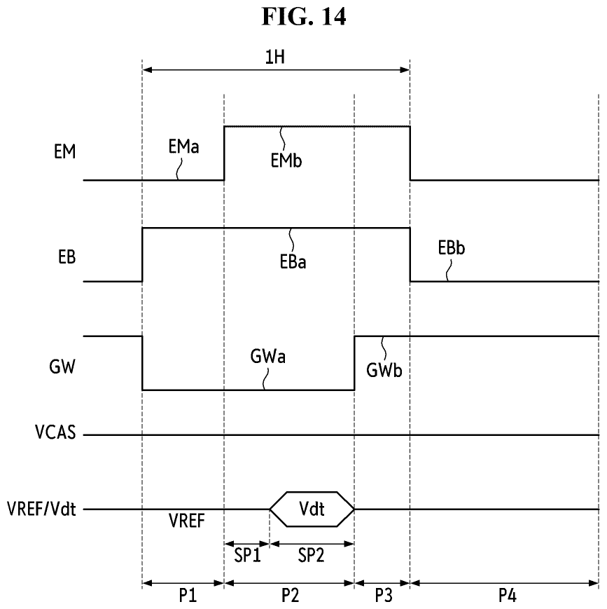

FIG. 14 is a timing diagram of the emission control signal EM, the initialization gate signal EB, the write gate signal GW, the cascode voltage VCAS, and the data voltage Vdt of FIG. 13.

Referring to FIG. 14, the display device 10 may operate based on a first period P1, a second period P2, a third period P3, and a fourth period P4.

The emission control signal EM, the initialization gate signal EB, and the write gate signal GW, which are provided as signals in the form of pulses, may have active voltages EMa, EBa, and GWa or non-active voltages EMb, EBb, and GWb, respectively, for each of the periods P1, P2, P3, and P4 described above. Here, the active voltages EMa, EBa, and GWa of the respective signals EM, EB, and GW described above may refer to voltages of a level that may turn on the corresponding transistor to which the corresponding signal is applied. In other words, the signal of the active voltage may have a value that is greater than the threshold voltage of the corresponding transistor. For example, when the transistor is an n-type transistor, the active voltage of the signal applied to the gate electrode of the corresponding transistor may refer to a high level (e.g., positive polarity level or high voltage level).

The non-active voltage of each signal EM, EB, GW may mean a voltage at a level capable of turning off a corresponding transistor. In other words, a signal of the non-active voltage may have a value that is less than the threshold voltage of the corresponding transistor. For example, when the corresponding transistor is an n-type transistor, the non-active voltage of the signal applied to the gate electrode of the corresponding transistor may mean a low level (e.g., negative polarity level or low voltage level).

In contrast, when the transistor is a p-type transistor, the active voltage of each of the signals EM, EB, and GW applied to the gate electrode of the transistor may refer to a low level (e.g., negative polarity level or low voltage level), and the non-active voltage of the signal applied to the gate electrode of the corresponding transistor may refer to a high level (e.g., positive polarity level or high voltage level).

For example, as illustrated in FIG. 14, the emission control signal EM may have the active voltage EMa of a low level and the non-active voltage EMb of a high level, the initialization gate signal EB may have the active voltage EBa of a high level and the non-active voltage EBb of a low level, and the write gate signal GW may have the active voltage GWa of a low level and the non-active voltage GWb of a high level.

The non-active voltage EMb of the emission control signal EM, the active voltage EBa of the initialization gate signal EB, and the non-active voltage GWb of the write gate signal GW may be the same. For example, the non-active voltage EMb of the emission control signal EM, the active voltage EBa of the initialization gate signal EB, and the non-active voltage GWb of the write gate signal GW may each have a voltage of about 5 V.

The active voltage EMb of the emission control signal EM, the non-active voltage EBb of the initialization gate signal EB, and the active voltage GWa of the write gate signal GW may be the same. For example, the active voltage EMb of the emission control signal EM, the non-active voltage EBb of the initialization gate signal EB, and the active voltage GWa of the write gate signal GW may each have a voltage of about 0 V.

The cascode voltage VCAS may be greater than a relatively small voltage between the active voltage and the non-active voltage of any one signal and less than a relatively large voltage. For example, between the active voltage EMa and the non-active voltage EMb of the emission control signal EM, the non-active voltage EMb may be greater than the active voltage EMa, and the cascode voltage VCAS may be greater than the active voltage EMa of the emission control signal EM and less than the non-active voltage EMb of the emission control signal EM. For another example, between the active voltage EBa and the non-active voltage EBb of the initialization gate signal EB, the active voltage EBa may be greater than the non-active voltage EBb, and the cascode voltage VCAS may be greater than the non-active voltage EBb of the initialization gate signal EB and less than the active voltage EBa of the initialization gate signal EB. For example, the cascode voltage VCAS may be greater than about 0 V and less than about 5 V. For example, the cascode voltage VCAS may be about 2 V.

In FIG. 14, one horizontal period 1H may be defined as a period in which the initialization gate signal EB is maintained at the active voltage EBa.

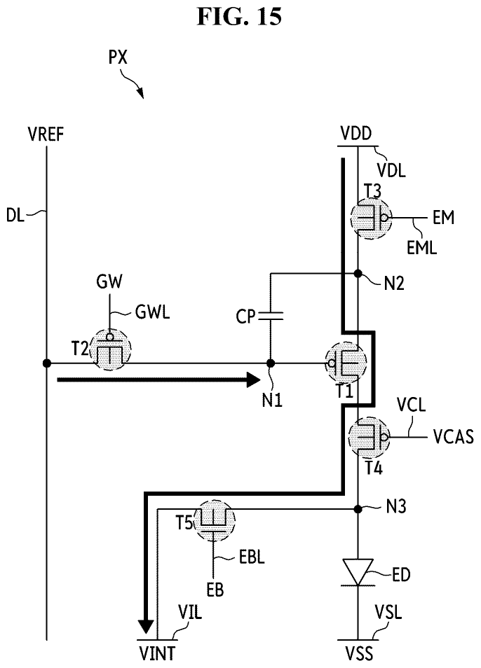

The operation of the display device 10 according to one or more embodiments will be described with reference to FIGS. 14, 15, 16, 17 and 18 as follows. In FIGS. 15 to 18, transistors surrounded by dotted circles are in a turn-on state, and transistors other than those surrounded by the dotted circles are in a turn-off state. In addition, arrows in FIGS. 15 to 18 indicate current flow.

First, the operation of the display device 10 in the first period P1 will be described with reference to FIGS. 14 and 15.

FIG. 15 is a diagram illustrating the operation of the display device 10 of FIG. 13 in the first period P1 of FIG. 14. The first period P1 may be, for example, an initialization period.

As illustrated in FIG. 14, in the first period P1, the initialization gate signal EB, the write gate signal GW, and the emission control signal EM may have the active voltages EBa, GWa, and EMa, respectively. Further, in the first period P1, the reference voltage VREF may be applied to the data line DL. The reference voltage VREF may be greater than the initialization voltage VINT and less than the driving voltage VDD, for example.

The initialization gate signal EB of the active voltage EBa may be applied to the gate electrode of the fifth transistor T5 through the initialization gate line EBL. Accordingly, the fifth transistor T5 may be turned on.

The write gate signal GW of the active voltage GWa may be applied to the gate electrode of the second transistor T2 through the write gate line GWL. Accordingly, the second transistor T2 may be turned on.

The emission control signal EM of the active voltage EMa may be applied to the gate electrode of the third transistor T3 through the emission control line EML. Accordingly, the third transistor T3 may be turned on.

The cascode voltage VCAS, which is a DC voltage, may be applied to the gate electrode of the fourth transistor T4 through the cascode line VCL. Accordingly, the fourth transistor T4 may be turned on. In this case, because the cascode voltage VCAS is greater than the active voltage GWa of the gate signal (e.g., the write gate signal GW) applied to a transistor (e.g., the second transistor T2) of the same type (e.g., p-type) as the fourth transistor T4, the turned-on fourth transistor T4 may be turned on at a lower level compared to another turned-on transistor (e.g., the second transistor T2). Therefore, the resistance of the turned-on fourth transistor T4 may be greater than the resistance of another turned-on transistor (e.g., the second transistor T2).

Because the second transistor T2 is turned on as described above, the reference voltage VREF from the data line DL may be applied to the gate electrode (e.g., the first node N1) of the first transistor T1 through the turned-on second transistor T2. In this case, the reference voltage VREF may be maintained at the first node N1 by the capacitor CP. Accordingly, the voltage of the gate electrode (e.g., the gate electrode of the first transistor T1) connected to the first node N1 may be initialized to the reference voltage VREF, and the first transistor T1 may be turned on.

Because each of the third transistor T3, the first transistor T1, the fourth transistor T4, and the fifth transistor T5 is turned on as described above, the source electrode (e.g., the second node N2) of the first transistor T1, the drain electrode of the first transistor T1, and the first electrode (e.g., the third node N3) of the light-emitting element ED may each be initialized to the initialization voltage VINT through the turned-on third transistor T3, the turned-on first transistor T1, the turned-on fourth transistor T4, and the turned-on fifth transistor T5.

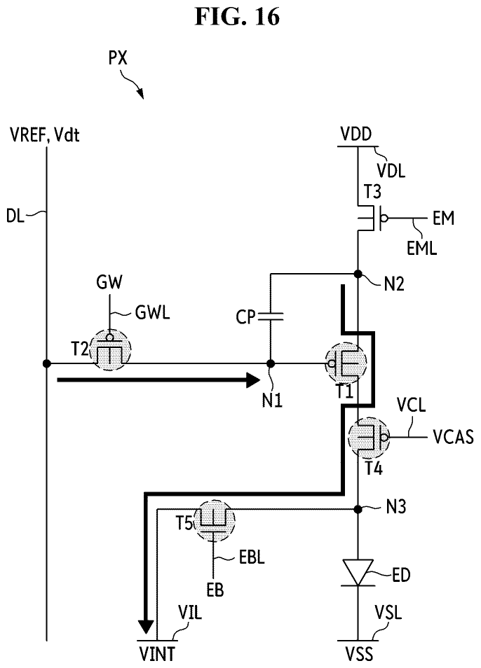

Next, the operation of the display device 10 in the second period P2 will be described with reference to FIGS. 14 and 16.

FIG. 16 is a diagram illustrating the operation of the display device 10 of FIG. 13 in the second period P2 of FIG. 14. The second period P2 may be, for example, a threshold voltage detection period and a data write period of the first transistor T1.

As illustrated in FIG. 14, in the second period P2, the initialization gate signal EB and the write gate signal GW may have the active voltages EBa and GWa, respectively. On the other hand, in the second period P2, the emission control signal EM may have the non-active voltage EMb. In addition, the reference voltage VREF and the data voltage Vdt may be applied to the data line DL in the second period P2. For example, the second period P2 may include a first sub-period SP1 and a second sub-period SP2 that are consecutive, and the reference voltage VREF may be applied to the data line DL in the first sub-period SP1, and the data voltage Vdt corresponding to the pixel PX may be applied to the data line DL in the second sub-period SP2.

The initialization gate signal EB of the active voltage EBa may be applied to the gate electrode of the fifth transistor T5 through the initialization gate line EBL. Accordingly, the fifth transistor T5 may be turned on.

The write gate signal GW of the active voltage GWa may be applied to the gate electrode of the second transistor T2 through the write gate line GWL. Accordingly, the second transistor T2 may be turned on.

The fourth transistor T4 may be maintained in a turned-on state by the cascode voltage VCAS that is a DC voltage.

The emission control signal EM of the non-active voltage EMb may be applied to the gate electrode of the third transistor T3 through the emission control line EML. Accordingly, the third transistor T3 may be turned off.

Because the second transistor T2 is maintained in a turned-on state as described above, the reference voltage VREF may be applied to and maintained at the first node N1, and the first transistor T1 may be turned on by the reference voltage VREF. Then, the current may flow through the turned-on first transistor T1. For example, the charge of the source electrode (e.g., the second node N2) of the first transistor T1 may be discharged to the initialization voltage line VIL through the turned-on first transistor T1, the turned-on fourth transistor T4, and the turned-on fifth transistor T5. Accordingly, the voltage of the second node N2 may gradually decrease. At the moment when the voltage of the second node N2 gradually decreases and the difference voltage (e.g., the gate-source voltage of the first transistor T1) between the voltage of the first node N1 and the voltage of the second node N2 reaches the threshold voltage of the first transistor T1, the first transistor T1 may be turned off, and the threshold voltage of the first transistor T1 at this time may be stored by the capacitor CP. In other words, the threshold voltage of the first transistor T1 may be detected at the moment when the first transistor T1 is turned off. Therefore, the threshold voltage of the first transistor T1 may be detected and stored in the capacitor CP in the first sub-period SP1 of the second period P2 in which the reference voltage VREF is applied to the data line DL.

Thereafter, in the second sub-period SP2 of the second period, the data voltage Vdt may be applied to the data line DL, and the data voltage Vdt of the data line DL may be applied to the first node N1 through the turned-on second transistor T1. In this case, the voltage of the second node N2 may be maintained at a voltage that is the sum of the data voltage Vdt and the threshold voltage of the first transistor T1 by the capacitor CP. For example, when the threshold voltage of the first transistor T1 is defined as “Vth,” the voltage of the second node N2 may have a value corresponding to “Vdt+|Vth|.” In other words, the data voltage Vdt and the threshold voltage of the first transistor T1 may be reflected to the second node N2.

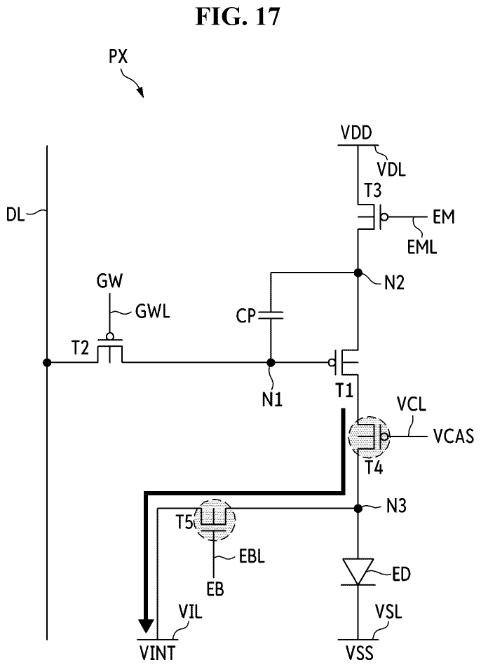

Next, the operation of the display device 10 in the third period P3 will be described with reference to FIGS. 14 and 17. The third period P3 may be an anode holding period.

FIG. 17 is a diagram illustrating the operation of the display device 10 of FIG. 13 in the third period P3 of FIG. 14.

As illustrated in FIG. 14, the initialization gate signal EB may have the active voltage EBa in the third period P3. On the other hand, the emission control signal EM and the write gate signal GW may have the non-active voltages EMb and GWb in the third period P3.

The initialization gate signal EB of the active voltage EBa may be applied to the gate electrode of the fifth transistor T5 through the initialization gate line EBL. Accordingly, the fifth transistor T5 may be turned on.

The emission control signal EM of the non-active voltage GWb may be applied to the gate electrode of the third transistor T3 through the emission control line EML. Accordingly, the third transistor T3 may be turned off.

The fourth transistor T4 may be maintained in a turned-on state by the cascode voltage VCAS that is a DC voltage.

The write gate signal GW of the non-active voltage GWb may be applied to the gate electrode of the second transistor T2 through the write gate line GWL. Accordingly, the second transistor T2 may be turned off.

After the threshold voltage of the first transistor T1 is detected, the first transistor T1 may be maintained in a turned-off state.

Because each of the fourth transistor T4 and the fifth transistor T5 is turned on as described above, the drain electrode of the first transistor T1 and the first electrode (e.g., the third node N3) of the light-emitting element ED may be initialized to the initialization voltage VINT through the turned-on fourth transistor T4 and the turned-on fifth transistor T5.

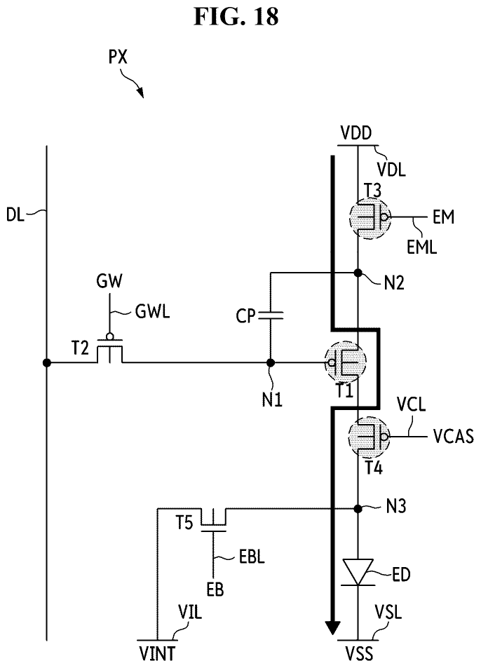

Next, the operation of the display device 10 in the fourth period P4 will be described with reference to FIGS. 14 and 18. The fourth period P4 may be, for example, an emission period P4.

FIG. 18 is a diagram illustrating the operation of the display device 10 of FIG. 3 in the fourth period P4 of FIG. 4.

As illustrated in FIG. 14, in the fourth period P4, the emission control signal EM may have the active voltage EMa. On the other hand, in the fourth period P4, the initialization gate signal EB and the write gate signal GW may have the non-active voltages EBb and GWb, respectively.

The emission control signal EM of the active voltage EMa may be applied to the gate electrode of the third transistor T3 through the emission control line EML. Accordingly, the third transistor T3 may be turned on.

The fourth transistor T4 may be maintained in a turned-on state by the cascode voltage VCAS that is a DC voltage.

The initialization gate signal EB of the non-active voltage EBb may be applied to the gate electrode of the fifth transistor T5 through the initialization gate line EBL. Accordingly, the fifth transistor T5 may be turned off.

The write gate signal GW of the non-active voltage GWb may be applied to the gate electrode of the second transistor T2 through the write gate line GWL. Accordingly, the second transistor T2 may be turned off.

Because the driving voltage VDD is applied to the source electrode (e.g., the second node N2) of the first transistor T1 by the turned-on third transistor T3, the voltage of the source electrode of the first transistor T1 may increase. Accordingly, the first transistor T1 may be turned on.

Because each of the third transistor T3, the first transistor T1, and the fourth transistor T4 is turned on as described above, a driving current may be supplied to the light-emitting element ED through the turned-on third transistor T3, the turned-on first transistor T1, and the turned-on fourth transistor T4. Therefore, the light-emitting element ED may emit light according to the driving current.

According to one or more embodiments, the pixel PX may include the fourth transistor T4 connected between the driving transistor (e.g., the first transistor T1) and the light-emitting element ED. In this case, the cascode voltage VCAS applied to the fourth transistor T4 may have a value between the active voltage GWa and the non-active voltage GWb of the gate signal (e.g., the write gate signal GW) applied to the gate electrode of another transistor (e.g., the second transistor T2) of the pixel PX. For example, the cascode voltage VCAS may be greater than the active voltage GWa of the gate signal (e.g., the write gate signal GW) applied to a transistor (e.g., the second transistor T2) of the same type (e.g., p-type) as the type of the fourth transistor T4, and may be less than the non-active voltage GWb of the gate signal (e.g., the write gate signal GW). Therefore, the resistance of the turned-on fourth transistor T4 may be greater than the resistance of another turned-on transistor (e.g., the second transistor T2). For example, in the fourth period T4, the turned-on fourth transistor T4 may have a resistance of several hundreds of mega ohms to several hundreds of giga ohms. Accordingly, even if a deviation occurs between the driving voltage VDD and the common voltage VSS due to the deterioration of the light-emitting element ED, the influence of the source-drain voltage of the first transistor T1 on the driving current may be substantially ignored due to the high resistance characteristics of the fourth transistor T4 and, thus, the deviation of the driving current of the first transistor T1 may be reduced or minimized. Therefore, even if the deviation occurs between the driving voltage VDD and the common voltage VSS due to the deterioration of the light-emitting element ED, the luminance of the light-emitting element ED may be maintained substantially uniformly in the fourth period P4. In other words, even if the light-emitting element ED deteriorates, the image quality deterioration of the display device 10 may be reduced or minimized.

The cascode voltage VCAS applied to the fourth transistor T4 may be greater than the non-active voltage EBb of the gate signal (e.g., the initialization gate signal EB) applied to a transistor (e.g., the fifth transistor T5) of the opposite type (e.g., n-type) to the type of the fourth transistor T4, and may be less than the active voltage EBb of the gate signal (e.g., the initialization gate signal EB).

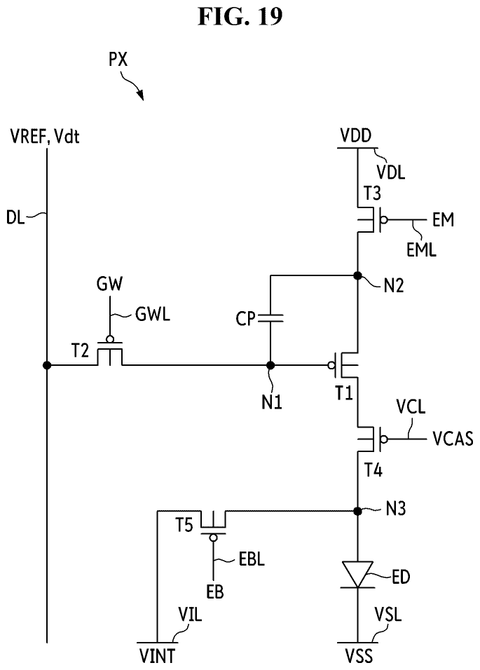

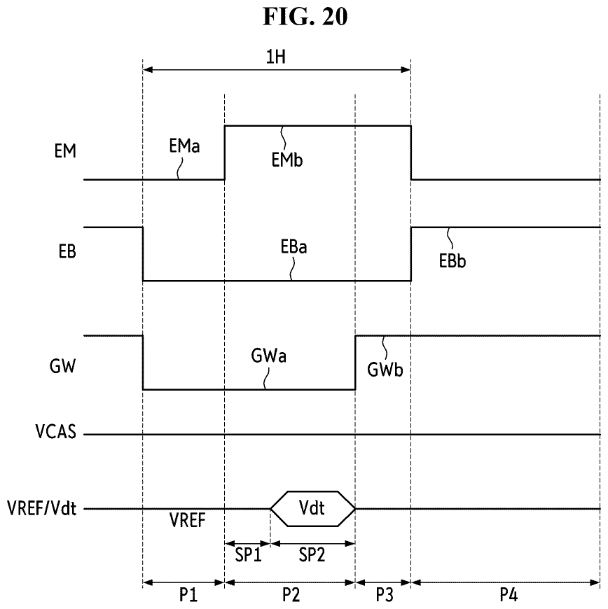

FIG. 19 is an equivalent circuit diagram of the pixel PX according to one or more other embodiments, and FIG. 20 is a timing diagram of the emission control signal EM, the initialization gate signal EB, the write gate signal GW, and the data signal Vdt of FIG. 19.

The pixel PX of FIG. 19 is different from the pixel PX of FIG. 13 described above in that the fifth transistor T5 is a p-type MOSFET, and the difference will be mainly described as follows.

As illustrated in FIG. 19, the fifth transistor T5 of the pixel PX may be a p-type MOSFET. Accordingly, as illustrated in FIG. 20, the initialization gate signal EB inputted to the gate electrode of the fifth transistor T5 may be different from the initialization gate signal EB of FIG. 4 described above. For example, as illustrated in FIG. 20, the initialization gate signal EB may have a low level (e.g., negative polarity level or low voltage level) as the active voltage EBa in each of the first period P1, the second period P2, and the third period P3, and may have a high level (e.g., positive polarity level or high voltage level) as the non-active voltage EBb in the fourth period P4.

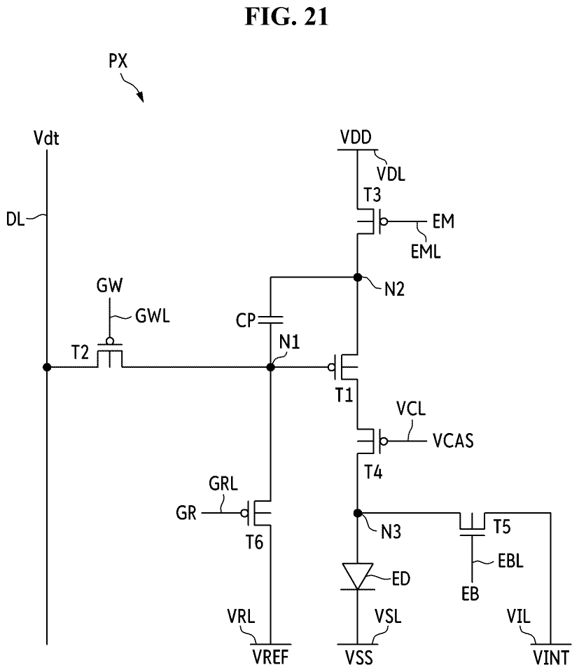

FIG. 21 is an equivalent circuit diagram of the pixel PX according to one or more embodiments.

The pixel of FIG. 21 is different from the pixel of FIG. 13 described above in that a sixth transistor T6 is further included, and the difference will be mainly described as follows.

As illustrated in FIG. 21, the pixel PX may include the light-emitting element ED, the first to sixth transistors T1 to T6, and the capacitor CP.

The light-emitting element ED, the first to fifth transistors T1 to T5, and the capacitor CP of FIG. 21 are the same as the light-emitting element ED, the first to fifth transistors T1 to T5, and the capacitor CP of FIG. 13, respectively, so that the description of the light-emitting element ED, the first to fifth transistors T1 to T5, and the capacitor CP of FIG. 21 refers to FIG. 13 and the related description.

As illustrated in FIG. 21, the sixth transistor T6 may be controlled by a reference gate signal GR, and the sixth transistor T6 may be connected between the first node N1 and the reference voltage line VRL. The sixth transistor T6 may include a gate electrode connected to a reference gate line GRL, a source electrode connected to the first node N1, and a drain electrode connected to the reference voltage line VRL. In addition, the sixth transistor T6 may further include a body electrode connected to the driving voltage line VDL. The reference gate signal GR may be applied to the reference gate line GRL, and the reference voltage VREF, which is a DC voltage, may be applied to the reference voltage line VRL.

The sixth transistor T6 described above may be a MOSFET. For example, the sixth transistor T6 may be a p-type MOSFET.

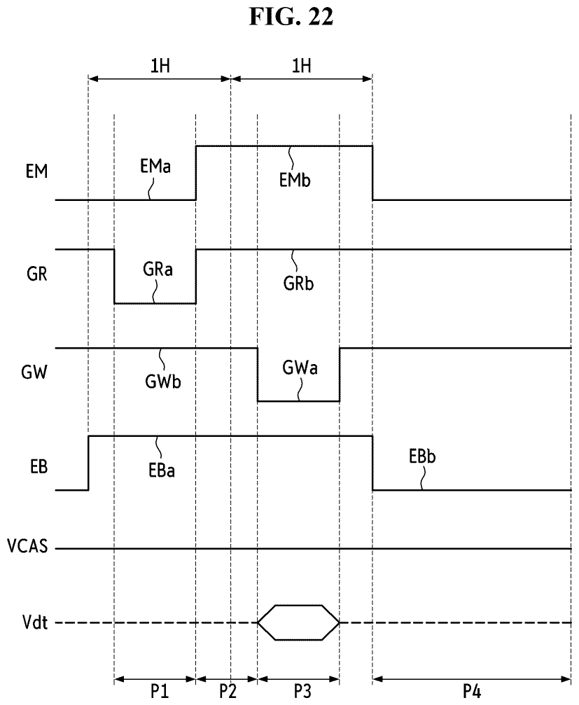

FIG. 22 is a timing diagram of the emission control signal EM, the reference gate signal GR, the write gate signal GW, the initialization gate signal EB, the cascode voltage VCAS, and the data voltage Vdt of FIG. 21.

Referring to FIG. 22, the display device 10 may operate based on a first period P1, a second period P2, a third period P3, and a fourth period P4.

The emission control signal EM, the reference gate signal GR, the write gate signal GW, and the initialization gate signal EB, which are provided as pulse signals, may have the active voltages EMa, GRa, GWa, and EBa or the non-active voltages EMb, GRb, GWb, and EBb, respectively, for each of the periods P1, P2, P3, and P4 described above. Here, the active voltage EMa, GRa, GWa, EBa of each signal EM, GR, GW, EB described above may mean a voltage at a level capable of turning on a corresponding transistor to which the corresponding signal is applied. In other words, the signal of the active voltage may have a value that is greater than the threshold voltage of the corresponding transistor. For example, when the corresponding transistor is an n-type transistor, the active voltage of the signal applied to the gate electrode of the corresponding transistor may mean a high level (e.g., positive polarity level or high voltage level).

The non-active voltage of each signal EM, GR, GW, EB may mean a voltage at a level capable of turning off a corresponding transistor. In other words, a signal of the non-active voltage may have a value that is less than the threshold voltage of the corresponding transistor. For example, when the corresponding transistor is an n-type transistor, the non-active voltage of the signal applied to the gate electrode of the corresponding transistor may mean a low level (e.g., negative polarity level or low voltage level).

In contrast, when the transistor is a p-type transistor, the active voltage of each of the signals EM, GR, GW, and EB applied to the gate electrode of the corresponding transistor may refer to a low level (e.g., negative polarity level or low voltage level), and the non-active voltage of the signal applied to the gate electrode of the corresponding transistor may refer to a high level (e.g., positive polarity level or high voltage level).

For example, as illustrated in FIG. 22, the emission control signal EM may have the active voltage EMa of a low level and the non-active voltage EMb of a high level, the reference gate signal GR may have an active voltage of a low level and a non-active voltage of a high level, the write gate signal GW may have the active voltage GWa of a low level and the non-active voltage GWb of a high level, and the initialization gate signal EB may have the active voltage EBa of a high level and the non-active voltage EBb of a low level.

The non-active voltage EMb of the emission control signal EM, the non-active voltage of the reference gate signal GR, the non-active voltage GWb of the write gate signal GW, and the active voltage EBa of the initialization gate signal EB may be the same. For example, the non-active voltage EMb of the emission control signal EM, the non-active voltage of the reference gate signal GR, the non-active voltage GWb of the write gate signal GW, and the active voltage EBa of the initialization gate signal EB may each have a voltage of about 0 V.

The active voltage EMb of the emission control signal EM, the active voltage of the reference gate signal GR, the active voltage GWa of the write gate signal GW, and the non-active voltage EBb of the initialization gate signal EB may be the same. For example, the active voltage EMb of the emission control signal EM, the active voltage of the reference gate signal GR, the active voltage GWa of the write gate signal GW, and the non-active voltage EBb of the initialization gate signal EB may each have a voltage of about 0 V.

Because the cascode voltage VCAS of FIGS. 21 and 22 is the same as the cascode voltage VCAS of FIG. 14 described above, the description of the cascode voltage VCAS of FIGS. 21 and 22 refers to FIG. 14 and the related description.

In FIG. 22, one horizontal period 1H may be defined as half of the period in which the initialization gate signal EB is maintained at the active voltage EBa.

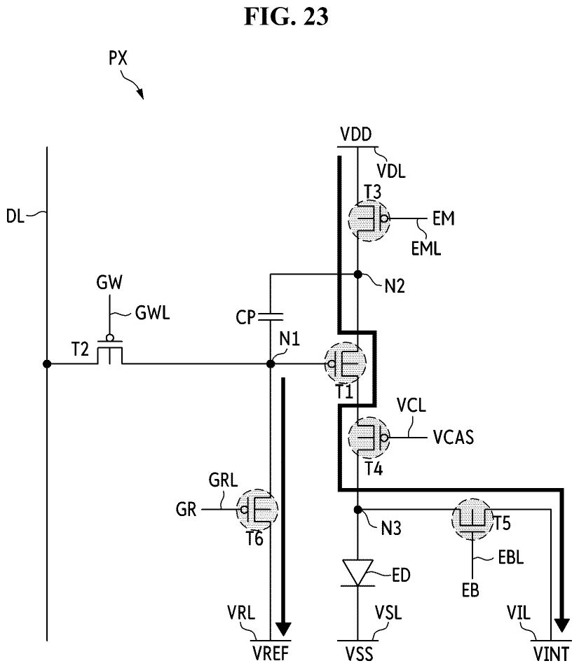

The operation of the display device 10 according to one or more embodiments will be described with reference to FIGS. 22, 23, 24, 25, and 26 as follows. In FIGS. 23 to 26, transistors surrounded by dotted circles are in a turn-on state, and transistors other than those surrounded by the dotted circles are in a turn-off state. In addition, arrows in FIGS. 22 to 25 indicate current flow.

First, the operation of the display device 10 in the first period P1 will be described with reference to FIGS. 22 and 23.

FIG. 23 is a diagram illustrating the operation of the display device 10 of FIG. 21 in the first period P1 of FIG. 22. The first period P1 may be, for example, an initialization period.

As illustrated in FIG. 22, in the first period P1, the emission control signal EM, the reference gate signal GR, and the initialization gate signal EB may have the active voltages EMa, GRa, and EBa, respectively. On the other hand, in the first period, the write gate signal GW may have the non-active voltage GWb.

The emission control signal EM of the active voltage EMa may be applied to the gate electrode of the third transistor T3 through the emission control line EML. Accordingly, the third transistor T3 may be turned on.

The reference gate signal GR of the active voltage GRa may be applied to the gate electrode of the sixth transistor T6 through the reference gate line GRL. Accordingly, the sixth transistor T6 may be turned on.

The initialization gate signal EB of the active voltage EBa may be applied to the gate electrode of the fifth transistor T5 through the initialization gate line EBL. Accordingly, the fifth transistor T5 may be turned on.

The write gate signal GW of the non-active voltage GWb may be applied to the gate electrode of the second transistor T2 through the write gate line GWL. Accordingly, the second transistor T2 may be turned off.

The cascode voltage VCAS, which is a DC voltage, may be applied to the gate electrode of the fourth transistor T4 through the cascode line VCL. Accordingly, the fourth transistor T4 may be turned on. As described above, the resistance of the turned-on fourth transistor T4 may be greater than the resistance of another turned-on transistor (e.g., the second transistor T2).

Because the sixth transistor T6 is turned on as described above, the reference voltage VREF from the reference voltage line VRL may be applied to the gate electrode (e.g., the first node N1) of the first transistor T1 through the turned-on sixth transistor T6. In this case, the reference voltage VREF may be maintained at the first node N1 by the capacitor CP. Accordingly, the voltage of the gate electrode (e.g., the gate electrode of the first transistor T1) connected to the first node N1 may be initialized to the reference voltage VREF, and the first transistor T1 may be turned on.

Because each of the third transistor T3, the first transistor T1, the fourth transistor T4, and the fifth transistor T5 is turned on as described above, the source electrode (e.g., the second node N2) of the first transistor T1, the drain electrode of the first transistor T1, and the first electrode (e.g., the third node N3) of the light-emitting element ED may each be initialized to the initialization voltage VINT through the turned-on third transistor T3, the turned-on first transistor T1, the turned-on fourth transistor T4, and the turned-on fifth transistor T5.

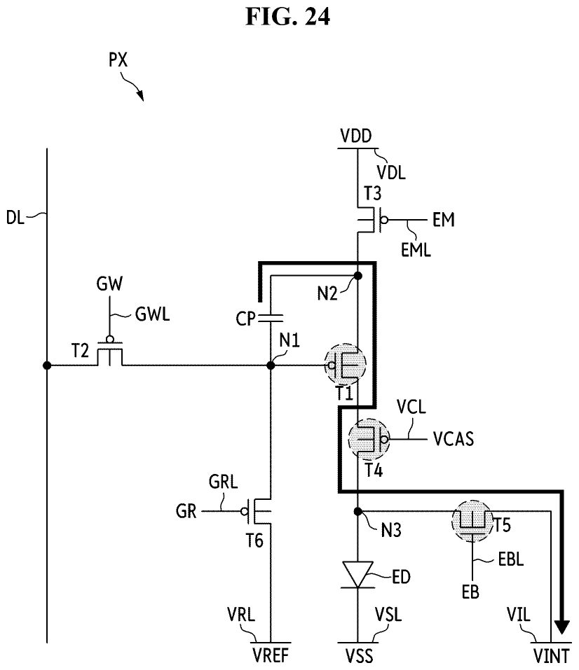

Next, the operation of the display device 10 in the second period P2 will be described with reference to FIGS. 22 and 24.

FIG. 24 is a diagram illustrating the operation of the display device 10 of FIG. 21 in the second period P2 of FIG. 22. The second period P2 may be, for example, the threshold voltage detection period of the first transistor T1.

As illustrated in FIG. 22, the initialization gate signal EB may have the active voltage EBa in the second period P2. On the other hand, in the second period P2, the emission control signal EM, the reference gate signal GR, and the write gate signal GW may have the non-active voltages EMb, GRb, and GWb, respectively.

The initialization gate signal EB of the active voltage EBa may be applied to the gate electrode of the fifth transistor T5 through the initialization gate line EBL. Accordingly, the fifth transistor T5 may be turned on.

The emission control signal EM of the non-active voltage EMb may be applied to the gate electrode of the third transistor T3 through the emission control line EML. Accordingly, the third transistor T3 may be turned off.

The reference gate signal GR of the non-active voltage GRb may be applied to the gate electrode of the sixth transistor T6 through the reference gate line GRL. Accordingly, the sixth transistor T6 may be turned off.

The write gate signal GW of the non-active voltage GWb may be applied to the gate electrode of the second transistor T2 through the write gate line GWL. Accordingly, the second transistor T2 may be turned off.

The first transistor T1 may be maintained in a turned-on state by the reference voltage VREF applied to the first node N1.

The fourth transistor T4 may be maintained in a turned-on state by the cascode voltage VCAS that is a DC voltage.

Because the second transistor T2 is turned off as described above, the gate electrode (e.g., the first node N1) of the first transistor T1 may be floated.

Because the third transistor T3 is turned off as described above, the driving voltage VDD is not charged to the source electrode (e.g., the second node N2) of the first transistor T1. Accordingly, the charge may be discharged from the source electrode of the first transistor T1 through the turned-on first transistor T1, the turned-on fourth transistor T4, and the turned-on fifth transistor T5. Accordingly, the voltage of the second node N2 decreases, and the voltage of the first node N1 in the floating state also decreases due to the coupling phenomenon of the capacitor CP. For example, the voltage of the source electrode of the first transistor T1 and the voltage of the gate electrode of the first transistor T1 may decrease together. Accordingly, the threshold voltage of the first transistor T1 may gradually increase. For example, the threshold voltage of the first transistor T1 may gradually increase due to the body effect of the first transistor T1. At the moment when the threshold voltage of the first transistor T1 gradually increases and becomes equal to the gate-source voltage (e.g., the difference voltage between the first node N1 and the second node N2) of the first transistor T1, the first transistor T1 may be turned off. At the moment when the first transistor T1 is turned off, the threshold voltage (e.g., effective threshold voltage) of the first transistor T1 may be stored in the capacitor CP.

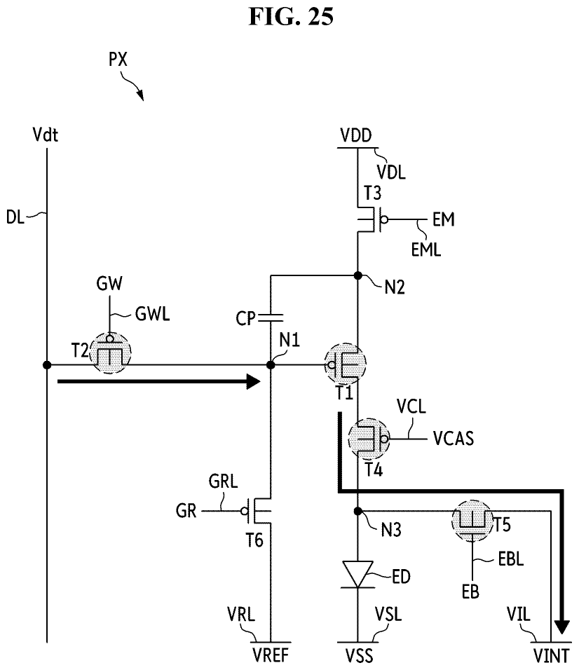

Next, the operation of the display device 10 in the third period P3 will be described with reference to FIGS. 22 and 25.

FIG. 25 is a diagram illustrating the operation of the display device 10 of FIG. 21 in the third period P3 of FIG. 22. The third period P3 may be, for example, a data write period.

As illustrated in FIG. 22, in the third period P3, the write gate signal GW and the initialization gate signal EB may have the active voltages GWa and EBa, respectively. On the other hand, in the third period P3, the emission control signal EM and the reference gate signal GR may have the non-active voltages EMb and GRb, respectively. In addition, in the third period P3, the data voltage Vdt corresponding to the pixel PX may be applied to the data line DL.

The write gate signal GW of the active voltage GWa may be applied to the gate electrode of the second transistor T2 through the write gate line GWL. Accordingly, the second transistor T2 may be turned on.

The initialization gate signal EB of the active voltage EBa may be applied to the gate electrode of the fifth transistor T5 through the initialization gate line EBL. Accordingly, the fifth transistor T5 may be turned on.

The emission control signal EM of the non-active voltage EMb may be applied to the gate electrode of the third transistor T3 through the emission control line EML. Accordingly, the third transistor T3 may be turned off.

The reference gate signal GR of the non-active voltage GRb may be applied to the gate electrode of the sixth transistor T6 through the reference gate line GRL. Accordingly, the sixth transistor T6 may be turned off.

The fourth transistor T4 may be maintained in a turned-on state by the cascode voltage VCAS that is a DC voltage.

Because the second transistor T2 is turned on as described above, the data voltage Vdt from the data line DL may be applied to the gate electrode (e.g., the first node N1) of the first transistor T1 through the turned-on second transistor T2. In this case, the voltage of the first node N1 may have a value corresponding to “Vdt+X,” and the voltage of the second node N2 may have a value corresponding to “Vth+((Vdt+X))*α).” Here, “Vth” may be the threshold voltage of the first transistor T1, “X” may be the voltage (e.g., the voltage of the second node N2 after the threshold voltage of the first transistor T1 is detected in the second period P2 and the first transistor T1 is turned off) of the second node N2 in the previous second period P2, and “α” may be the capacitance ratio of capacitors. For example, “α” may have a value corresponding to “C1/(C1+Cs_para).” Here, “C1” may be the capacitance of the capacitor CP, and “Cs_para” may be the sum of the capacitance of the parasitic capacitor and the capacitance of the channel region of the first transistor T1, which is viewed from the source electrode side of the first transistor T1.

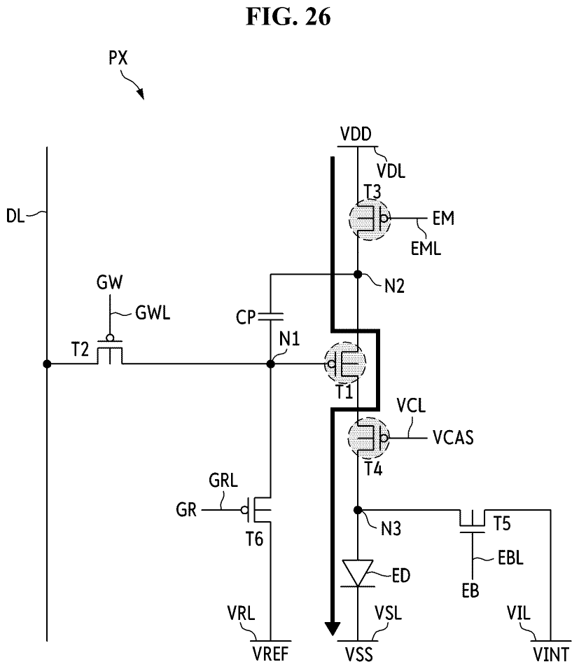

Next, the operation of the display device 10 in the fourth period P4 will be described with reference to FIGS. 22 and 26.

FIG. 26 is a diagram illustrating the operation of the display device 10 of FIG. 21 in the fourth period P4 of FIG. 22. The fourth period P4 may be, for example, an emission period.

As illustrated in FIG. 22, in the fourth period P4, the emission control signal EM may have the active voltage EMa. On the other hand, in the fourth period P4, the reference gate signal GR, the write gate signal GW, and the initialization gate signal EB may have the non-active voltages GRb, GWb, and EBb, respectively.

The emission control signal EM of the active voltage EMa may be applied to the gate electrode of the third transistor T3 through the emission control line EML. Accordingly, the third transistor T3 may be turned on.

The reference gate signal GR of the non-active voltage GRb may be applied to the gate electrode of the sixth transistor T6 through the reference gate line GRL. Accordingly, the sixth transistor T6 may be turned off.

The write gate signal GW of the non-active voltage GWb may be applied to the gate electrode of the second transistor T2 through the write gate line GWL. Accordingly, the second transistor T2 may be turned off.

The initialization gate signal EB of the non-active voltage EBb may be applied to the gate electrode of the fifth transistor T5 through the initialization gate line EBL. Accordingly, the fifth transistor T5 may be turned off.

The fourth transistor T4 may be maintained in a turned-on state by the cascode voltage VCAS that is a DC voltage.

Because the driving voltage VDD is applied to the source electrode (e.g., the second node N2) of the first transistor T1 by the turned-on third transistor T3, the voltage of the source electrode of the first transistor T1 may increase. Accordingly, the first transistor T1 may be turned on.

Because each of the third transistor T3, the first transistor T1, and the fourth transistor T4 is turned on as described above, a driving current may be supplied to the light-emitting element ED through the turned-on third transistor T3, the turned-on first transistor T1, and the turned-on fourth transistor T4. Therefore, the light-emitting element ED may emit light according to the driving current.

In this case, the voltage of the first node N1 may have a value corresponding to “(Vdt+X)+(VDD−(Vth((Vdt+X)*α))),” and the voltage of the second node N2 may have a value corresponding to the driving voltage VDD.

According to one or more embodiments, because the cascode voltage VCAS applied to the fourth transistor T4 is greater than the active voltage GWa of the gate signal (e.g., the write gate signal GW) applied to a transistor (e.g., the second transistor T2) of the same type (e.g., p-type) as the fourth transistor T4, the turned-on fourth transistor T4 may be turned on at a lower level compared to another turned-on transistor (e.g., the second transistor T2). Therefore, the resistance of the turned-on fourth transistor T4 may be greater than the resistance of another turned-on transistor (e.g., the second transistor T2). For example, in the fourth period T4, the turned-on fourth transistor T4 may have a resistance of several hundreds of mega ohms to several hundreds of giga ohms. Accordingly, even if a deviation occurs between the driving voltage VDD and the common voltage VSS due to the deterioration of the light-emitting element ED, the influence of the source-drain voltage of the first transistor T1 may be substantially ignored due to the high resistance characteristics of the fourth transistor T4 and, thus, the deviation of the driving current of the first transistor T1 may be reduced or minimized. Therefore, even if the deviation occurs between the driving voltage VDD and the common voltage VSS due to the deterioration of the light-emitting element ED, the luminance of the light-emitting element ED may be maintained substantially uniformly in the fourth period P4. In other words, even if the light-emitting element ED deteriorates, the image quality deterioration of the display device 10 may be reduced or minimized.

In some embodiments, the cascode voltage VCAS applied to the fourth transistor T4 may be greater than the non-active voltage EBb of the gate signal (e.g., the initialization gate signal EB) applied to a transistor (e.g., the fifth transistor T5) of the opposite type (e.g., n-type) to the type of the fourth transistor T4.

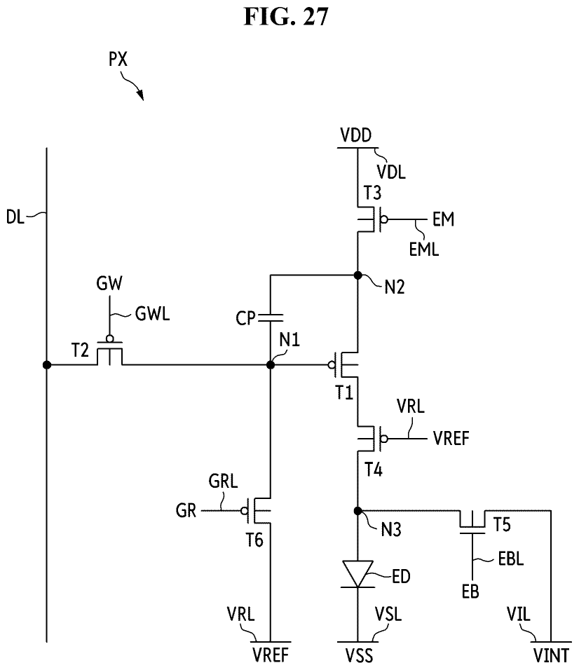

FIG. 27 is an equivalent circuit diagram of the pixel PX according to one or more other embodiments.

The pixel of FIG. 27 is different from the pixel of FIG. 21 described above in the signal inputted to the gate electrode of the fourth transistor T4, and the difference will be mainly described as follows.

As illustrated in FIG. 27, the reference voltage line VRL may be connected to the gate electrode of the fourth transistor T4. The reference voltage VREF from the reference voltage line VRL may be applied to the gate electrode of the fourth transistor T4. In this case, the reference voltage VREF may be about 2 V.

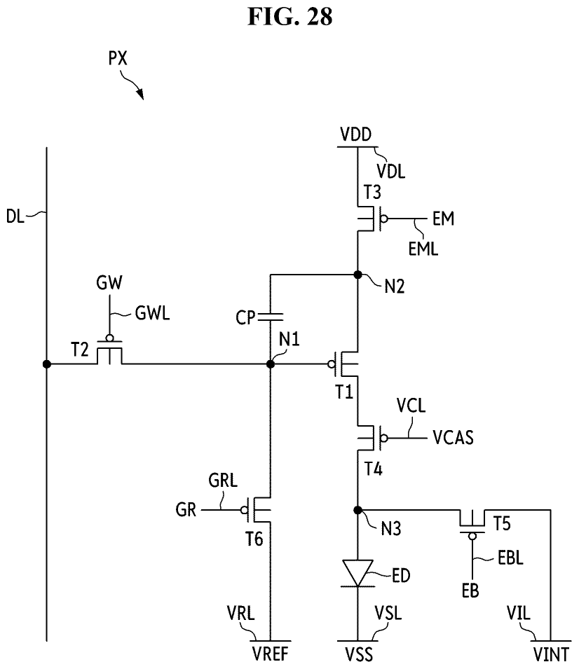

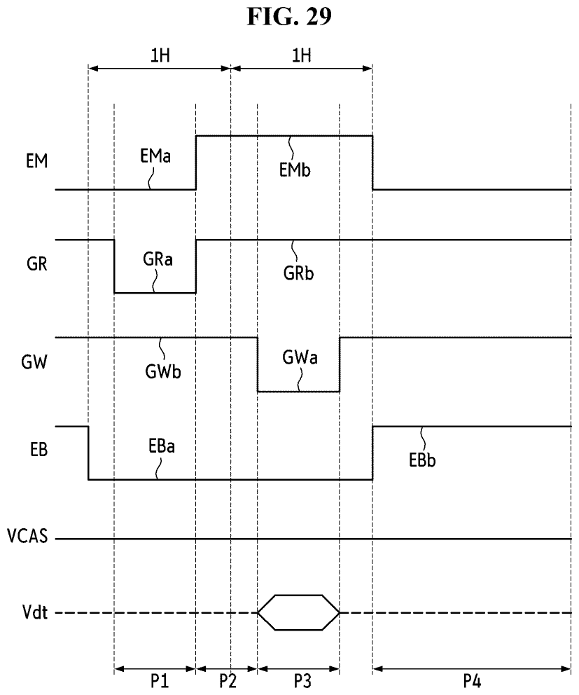

FIG. 28 is an equivalent circuit diagram of the pixel PX according to one or more other embodiments, and FIG. 29 is a timing diagram of the emission control signal EM, the reference gate signal GR, the write gate signal GW, the initialization gate signal EB, the cascode voltage VCAS, and the data signal Vdt of FIG. 28.

The pixel PX of FIG. 28 is different from the pixel PX of FIG. 21 described above in that the fifth transistor T5 is a p-type MOSFET, and the difference will be mainly described as follows.

As illustrated in FIG. 28, the fifth transistor T5 of the pixel PX may be a p-type MOSFET. Accordingly, as illustrated in FIG. 29, the initialization gate signal EB inputted to the gate electrode of the fifth transistor T5 may be different from the initialization gate signal EB of FIG. 21 described above. For example, as illustrated in FIG. 29, the initialization gate signal EB may have a low level (e.g., negative polarity level or low voltage level) as the active voltage EBa in each of the first period P1, the second period P2, and the third period P3, and may have a high level (e.g., positive polarity level or high voltage level) as the non-active voltage EBb in the fourth period P4.

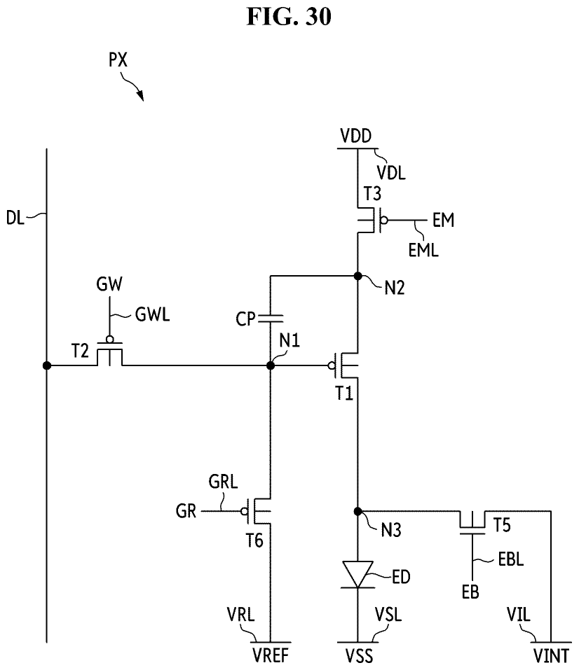

FIG. 30 is an equivalent circuit diagram of the pixel PX according to one or more other embodiments.

The pixel PX of FIG. 30 is different from the pixel PX of FIG. 21 described above in that the fourth transistor T4 is not included, and the difference will be mainly described as follows.

As illustrated in FIG. 30, the pixel PX may include the light-emitting element ED, the first transistor T1, the second transistor T2, the third transistor T3, the fifth transistor T5, the sixth transistor T6, and the capacitor CP. In other words, the fourth transistor T4 of the pixel PX may be omitted.

Because the fourth transistor T4 is omitted, the first transistor T1 may be directly connected to the third node N3. For example, the drain electrode of the first transistor T1 may be directly connected to the third node N3 (or the first electrode of the light-emitting element ED).

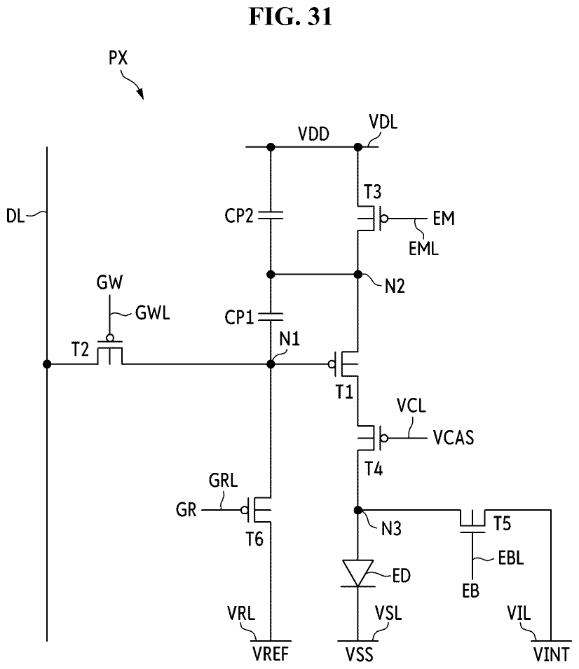

FIG. 31 is an equivalent circuit diagram of the pixel PX according to one or more other embodiments.

The pixel PX of FIG. 31 is different from the pixel PX of FIG. 21 described above in that a plurality of capacitors CP1 and CP2 are included, and the difference will be mainly described as follows.

As illustrated in FIG. 31, the pixel PX may include the first capacitor CP1 and the second capacitor CP1. For example, the pixel PX may further include the second capacitor CP2.

Because the first capacitor CP1 of FIG. 31 is the same as the capacitor CP of FIG. 21, the description of the first capacitor CP1 refers to FIG. 21 and the related description.

The second capacitor CP2 may be connected between the driving voltage line VDL and the second node N2. The capacitance of the second capacitor CP2 and the capacitance of the first capacitor CP1 may be different. For example, the capacitance of the first capacitor CP1 may be greater than the capacitance of the second capacitor CP2.

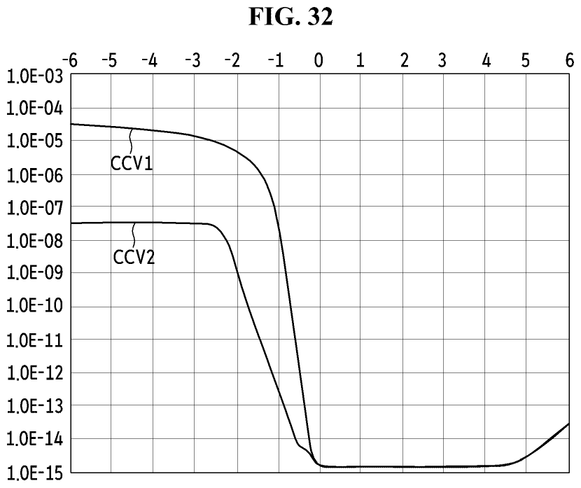

FIGS. 32, 33, 34, and 35 are diagrams illustrating aspects of a display device according to one or more embodiments.

The X-axis of FIG. 32 represents a data voltage, and the Y-axis of FIG. 32 represents a driving current. FIG. 32 represents a voltage-current characteristic curve of a driving transistor (e.g., the first transistor T). For example, FIG. 32 represents a voltage-current characteristic curve CCV1 of a driving transistor of a comparative example and a voltage-current characteristic curve CCV2 of a driving transistor of one or more embodiments.

As illustrated in FIG. 32, the voltage-current characteristic curve CCV2 of the driving transistor of one or more embodiments may have a slope gentler than the slope of the voltage-current characteristic curve CCV1 of the driving transistor of the comparative example. For example, the display device 10 according to one or more embodiments illustrated in FIG. 3 includes the third transistor T3 coupled as a diode, so that the voltage-current characteristic curve CCV2 of the driving transistor according to one or more embodiments may have a gentle slope. Accordingly, the display device 10 according to one or more embodiments may use a wider range of data voltage. Therefore, the display device 10 according to one or more embodiments may display an image with a precise grayscale, thereby improving the image quality of the display device.

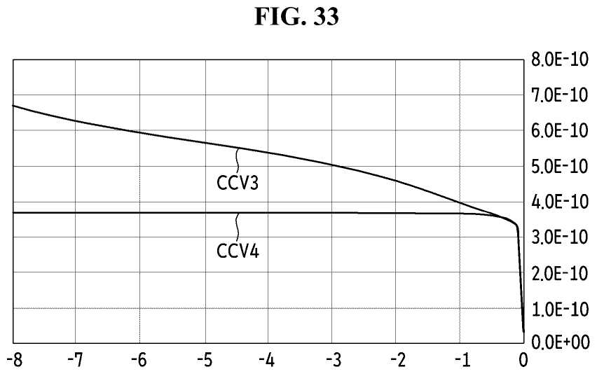

The X-axis of FIG. 33 represents a voltage deviation between the driving voltage VDD and the common voltage VSS, and the Y-axis of FIG. 33 represents the driving current. FIG. 33 represents the voltage deviation-current characteristic curve of the driving transistor (e.g., the first transistor T). For example, FIG. 33 represents a voltage deviation-current characteristic curve CCV3 of a driving transistor of a comparative example and a voltage-current characteristic curve CCV4 of a driving transistor of one or more embodiments.

As illustrated in FIG. 33, the voltage deviation-current characteristic curve CCV3 of the driving transistor of the comparative example varies greatly depending on the voltage deviation, whereas the voltage deviation-current characteristic curve CCV4 of the driving transistor of one or more embodiments may have a linear shape regardless of the voltage deviation. For example, the display device 10 according to one or more embodiments illustrated in FIG. 3 includes the fourth transistor T4 that may serve as a resistor in a turn-on state, so that the voltage deviation-current characteristic curve of the driving transistor according to one or more embodiments may provide a driving current of a substantially constant magnitude regardless of the deviation between the driving voltage and the common voltage. Therefore, even if the voltage deviation occurs due to the deterioration of the light-emitting element ED, the image quality deterioration of the display device 10 may be reduced or minimized.

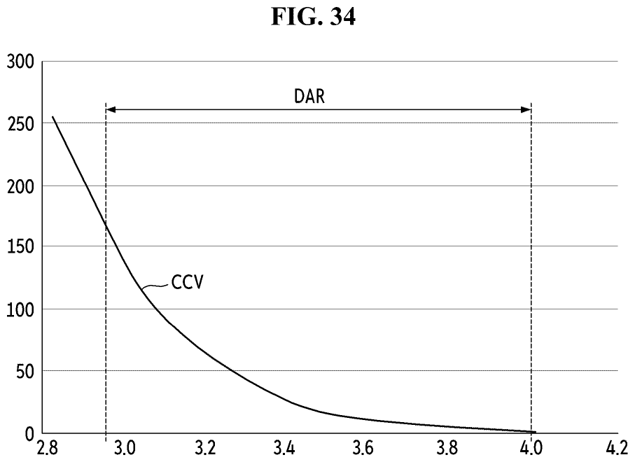

The X-axis of FIG. 34 represents a data voltage, and the Y-axis of FIG. 34 represents a grayscale. A characteristic curve CCV of FIG. 34 is a data voltage-grayscale characteristic curve CCV of the display device 10 according to one or more embodiments. As illustrated in FIG. 34, the display device 10 according to one or more embodiments may have a wide range of data voltage. For example, the display device according to one or more embodiments illustrated in FIG. 3 includes the fourth transistor T4 that may serve as a resistor in a turn-on state, so that the range of the data voltage may increase. For example, the display device 10 according to one or more embodiments may express a luminance of 0 grayscale to 255 grayscale in a wide data voltage range DAR of about about 1.2 V.

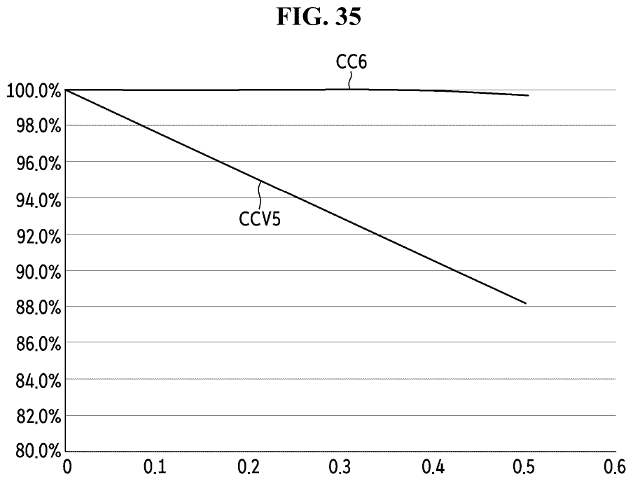

The X-axis of FIG. 35 represents a shift voltage of the light-emitting element ED due to the deterioration of the light-emitting layer of the light-emitting element ED, and the Y-axis of FIG. 35 represents a current holding ratio of the light-emitting element ED. For example, FIG. 35 shows a characteristic curve CCV5 for the shift voltage-current holding ratio of the comparative example and a characteristic curve CCV6 for the shift voltage-current holding ratio of the display device according to one or more embodiments.

As shown in FIG. 35, the shift voltage-current holding ratio characteristic curve CCV5 of the comparative example shows large variation in the current holding ratio depending on the degree of deterioration of the light-emitting element ED, whereas the shift voltage-current holding ratio characteristic curve CCV6 of one or more embodiments shows a current holding ratio of substantially 100% regardless of the degree of deterioration of the light-emitting element ED. For example, the display device 10 according to one or more embodiments shown in FIG. 3 includes the third transistor T3 and the fourth transistor T4, so that the voltage holding ratio of substantially 100% may be maintained regardless of the degree of deterioration of the light-emitting element ED.

The display device 10 may be applied to various electronic devices. An electronic device according to one or more embodiments may include the above-described display device 10, and may further include, in addition to the display device 10, a module or device having other additional functions.

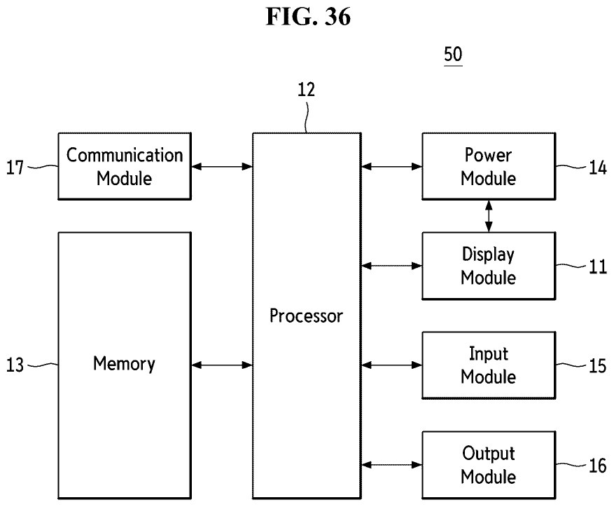

FIG. 36 is a block diagram of an electronic device according to one or more embodiments. Referring to FIG. 36, an electronic device 50 according to one or more embodiments may include a display module 11, a processor 12, a memory 13, and a power module 14. The electronic device 50 may further include an input module 15, a non-image output module 16, and/or a communication module 17.

The electronic device 50 may output various information in the form of images through the display module 11. When the processor 12 executes an application stored in the memory 13, image information provided by the application may be provided to a user through the display module 11. The power module 14 may include a power supply module, such as a power adapter or a battery device, and a power conversion module that converts the power supplied by the power supply module to generate the power required for the operation of the electronic device 50. The input module 15 may provide input information to the processor 12 and/or the display module 11. The non-image output module 16 may serve to receive information other than images, such as sound, haptics, luminescence, etc., sent from the processor 12, and provide it to the user. The communication module 17 is a module responsible for the transmission and reception of information between the electronic device 50 and an external device, and may include a receiver and a transmitter.

At least one of each of the components of the above-described electronic device 50 may be included in the display device according to the embodiments described above. Further, some of individual modules functionally included in one module may be included in the display device and some others may be provided separately from the display device. For example, the display device may include the display module 11, and the processor 12, the memory 13, and/or the power module 14 may be provided in the form of other devices in the electronic device 10 other than the display device.

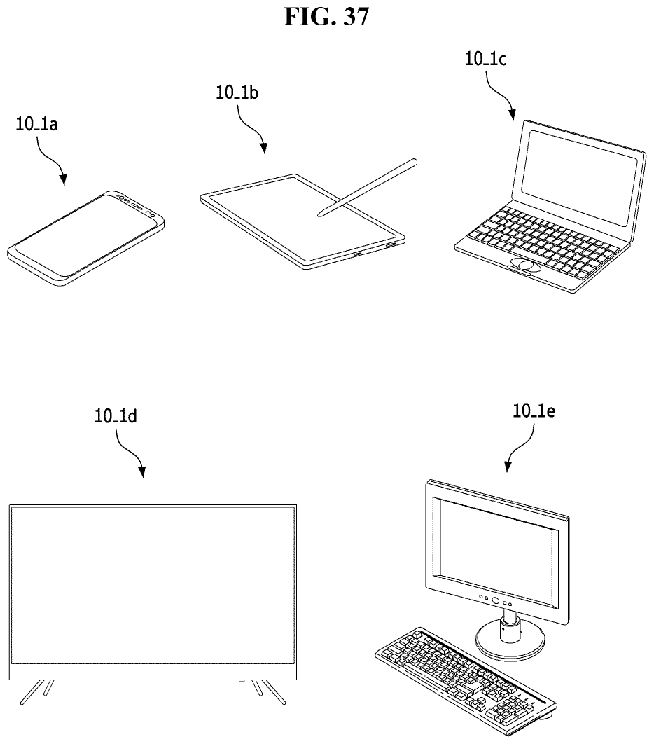

FIGS. 37, 38 and 39 are schematic diagrams illustrating electronic devices according to various embodiments. FIGS. 37 to 39 illustrate examples of various electronic devices to which the display device 10 according to the above-described embodiments are applied.

FIG. 37 shows a smartphone 10_1a, a tablet PC 10_1b, a laptop 10_1c, a TV 10_1d, and a desk monitor 10_1e as examples of electronic devices.

The smartphone 10_1a may include a communication module and an input module, such as a touch sensor, etc., in addition to the display module 11. The smartphone 10_1a may process the information received through the communication module or input module and display the processed information through the display module of the display device.

Each of the tablet PC 10_1b, the laptop 10_1c, the TV 10_1d, and the desk monitor 10_1e may include a display and an input module, similarly to the smartphone 10_1a, and may further include a communication module in some cases.

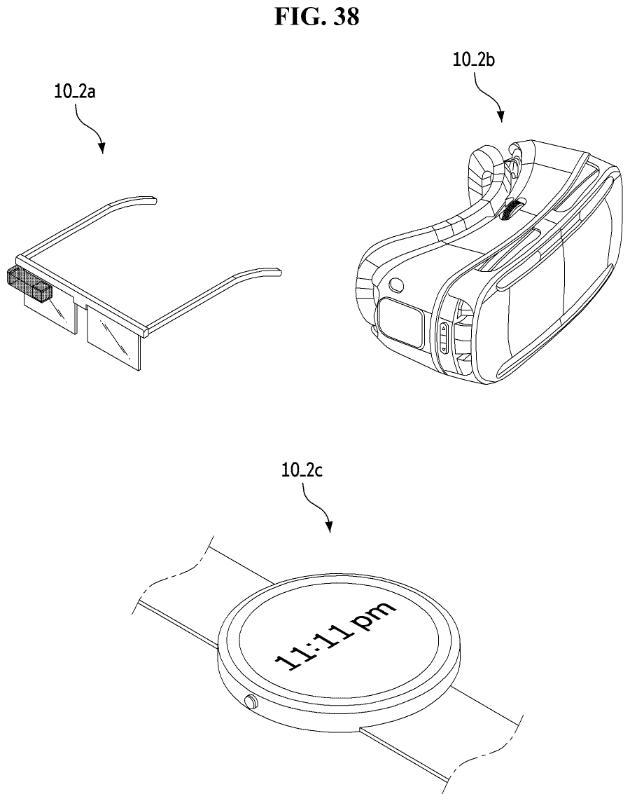

FIG. 38 illustrates a case in which an electronic device including a display module is applied to a wearable electronic device. The wearable electronic device may be smart glasses 10_2a, a head-mounted display 10_2b, a smart watch 10_2c, and the like.

The smart glasses 10_2a and the head-mounted display 10_2b may include a display module that outputs a display image and a reflector that reflects the outputted display image to provide it to the user's eyes, thereby providing the user with a virtual reality or augmented reality screen.

The smart watch 10_2c may include a biometric sensor as an input device, and may provide biometric information recognized through the biometric sensor to the user through a display module.

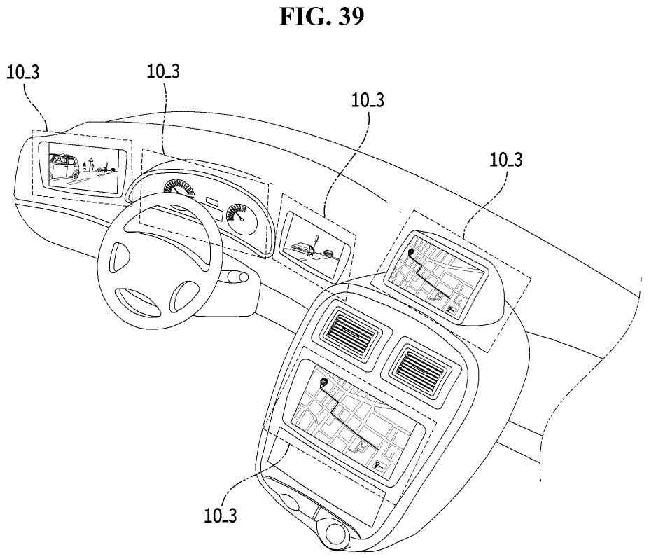

FIG. 39 illustrates a case in which an electronic device including a display module is applied to a vehicle. For example, an electronic device 10_3 may be applied to a dashboard or center fascia of a vehicle, or to a center information display (CID) placed in the dashboard of the vehicle or a room mirror display that replaces a side mirror.

In concluding the detailed description, those skilled in the art will appreciate that many variations and modifications can be made to the embodiments without substantially departing from the aspects of the present disclosure. Therefore, the disclosed embodiments are used in a generic and descriptive sense only and not for purposes of limitation.

What is claimed is:

1. A display device comprising a pixel,
wherein the pixel comprises:
a light-emitting element connected between a driving voltage line and a common voltage line;
a first transistor connected between the driving voltage line and the light-emitting element, and comprising a gate electrode connected to a first node and a source electrode connected to a second node;
a second transistor comprising a gate electrode connected to a gate line and configured to receive a gate signal, a source electrode connected to a data line, and a drain electrode connected to the first node; and
a fourth transistor connected between the first transistor and the light-emitting element, and comprising a gate electrode configured to receive a control signal having a value between an active voltage of the gate signal and a non-active voltage of the gate signal.

2. The display device of claim 1, wherein the fourth transistor and the second transistor comprise a same type of transistor, and
wherein the control signal is greater than the active voltage and less than the non-active voltage.

3. The display device of claim 1, wherein the control signal comprises a direct current signal.

4. The display device of claim 1, wherein the control signal comprises a pulse signal having a non-active voltage, and an active voltage having a value between the active voltage of the gate signal and the non-active voltage of the gate signal.

5. The display device of claim 4, wherein the fourth transistor and the second transistor comprise a same type of transistor, and
wherein the active voltage of the control signal is greater than an active voltage of the gate signal and less than a non-active voltage of the gate signal.

6. The display device of claim 1, wherein the pixel further comprises a fifth transistor connected between an initialization voltage line and a contact point between the fourth transistor and the light-emitting element.

7. The display device of claim 6, wherein the fifth transistor comprises a type of transistor that is opposite to that of the fourth transistor.

8. The display device of claim 7, wherein the control signal has a value between an active voltage of an initialization gate signal configured to be applied to the fifth transistor and a non-active voltage of the initialization gate signal.

9. The display device of claim 8, wherein the control signal comprises a pulse signal having a non-active voltage, and an active voltage that is greater than the non-active voltage of the initialization gate signal and less than the active voltage of the initialization gate signal.

10. The display device of claim 1, wherein the pixel further comprises a third transistor connected between the driving voltage line and the second node.

11. The display device of claim 10, wherein the gate electrode of the third transistor is connected to the second node.

12. The display device of claim 10, wherein the gate electrode of the third transistor is connected to an emission control line configured to transmit an emission control signal.

13. The display device of claim 1, wherein the pixel further comprises a sixth transistor connected between the first node and a reference voltage line.

14. The display device of claim 1, wherein the pixel further comprises:
a third transistor connected between the driving voltage line and the second node, and comprising a gate electrode connected to the second node;
a fifth transistor connected between an initialization voltage line and a contact point between the fourth transistor and the light-emitting element; and
a capacitor connected between the driving voltage line and the first node, and
wherein the control signal comprises a pulse-shaped emission control signal.

15. The display device of claim 1, wherein the pixel further comprises:
a third transistor connected between the driving voltage line and the second node;
a fifth transistor connected between and an initialization voltage line and a contact point between the fourth transistor and the light-emitting element; and
a capacitor connected between the driving voltage line and the first node, and
wherein the control signal comprises a cascode voltage, which comprises a direct current voltage.

16. The display device of claim 15, wherein the pixel further comprises a sixth transistor connected between the first node and a reference voltage line.

17. An electronic device comprising:
a display device having a pixel, the pixel comprising:
a light-emitting element connected between a driving voltage line and a common voltage line;
a first transistor connected between the driving voltage line and the light-emitting element, and comprising a gate electrode connected to a first node and a source electrode connected to a second node;
a second transistor comprising a gate electrode configured to receive a gate signal from a gate line, a source electrode connected to a data line, and a drain electrode connected to the first node; and
a fourth transistor connected between the first transistor and the light-emitting element, and comprising a gate electrode configured to receive a control signal having a value between an active voltage of the gate signal and a non-active voltage of the gate signal.

18. The electronic device of claim 17, wherein the fourth transistor and the second transistor comprise a same type of transistor, and
wherein the control signal is greater than the active voltage and less than the non-active voltage.

19. The electronic device of claim 17, wherein the control signal comprises a direct current signal.

20. The electronic device of claim 17, wherein the control signal comprises a pulse signal having a non-active voltage, and an active voltage having a value between the active voltage of the gate signal and the non-active voltage of the gate signal.
